(19) United States
(12) Patent Application Publication
(10) Pub. No.: US 2001/0029583 A1
(43) Pub. Date: Oct. 11, 2001

(54) Video content distribution system including an interactive kiosk, a portable content storage device, and a set-top box

(76) Inventors: Dennis Palatov, Portland, OR (US); Michael Bajc, Mission Viejo, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/785,945

(22) Filed: Feb. 16, 2001

Related U.S. Application Data
(63) Continuation-in-part of application No. 09/506,261, filed on Feb. 17, 2000.

(51) Int. Cl. H04L 9/32; G06F 11/30; G06F 12/14

(52) U.S. Cl. 713/193

(57) ABSTRACT

A portable content storage device is configured to hold digitally encoded video content on a disk drive. A user connects the device to a publicly located compatible interactive kiosk that stores several encoded content units, such as feature-length films. The user selects content units, and the kiosk copies the selections onto the device. At home, the user connects the device to a compatible set-top box that presents the content units as an output signal to a television set. The set-top box accumulates information related to the use of the video content units, such as how much of a content unit has been viewed and/or how many times it has been viewed. The set-top box then writes the information to the device. The information is read by the kiosk the next time the user connects the device to the kiosk and the user is billed for the use of the content.

### BACKGROUND OF THE INVENTION

1. Field of the Invention

This invention relates generally to systems for distribution, use, and payment for the use of video content and, more particularly, the invention relates to a video content distribution system including an interactive kiosk, a portable content storage device, and a set-top box.

2. Description of the Related Art

Present video content distribution systems include broadcast television, cable television, pay-per-view cable television and satellite television, as well as videocassette and DVD sales and rentals. Each of these systems has inherent limitations and disadvantages.

Broadcast and cable television allow the owner of the content only limited control over the use of the content once it is broadcast. In order to generate revenue, television is generally advertisement supported. Content presentations, therefore, are frequently interrupted with advertisements. Unless the content is recorded by a user and subsequently replayed, the content must be viewed when and as broadcast.

Pay-per-view cable television allows the collection of a fee in exchange for the presentation of video content, and thus advertisements can be eliminated from a presentation. Due to the nature of most pay-per-view systems, recording and playback is generally difficult. Consequently, pay-per-view presentations generally must also be viewed when and as broadcast.

Videocassettes and DVDs, which can be purchased or rented, allow video content to be presented when and as the user wishes it presented. In the case of a purchase, the user must pay full price for the content regardless of how many times the content is used. In the case of a rental, the user is burdened by the need to return the videocassette or DVD within a required amount of time, or face additional charges. Since consumers are generally satisfied with one presentation of a program, the rental market has far exceeded the purchase market for video content.

Many a movie renter has chosen what appeared to be an interesting selection at the video store. After a half-hour, however, the renter decides that the movie is not worth watching. Yet, the renter continues to watch the rest simply because it has already been paid for. And of course, there is always the situation when the renter's preferred selection is out of stock.

DIVX is another technology that attempted to combine some aspects of purchase and rental on a DVD-type system. A user purchases a DIVX DVD for a fee comparable to a rental. The DIVX DVD as sold can be used without an additional fee on a DIVX enabled player during an initial two-day period starting with the first viewing. The player gathers and stores data regarding the use of the DIVX DVD and periodically connects through a phone line to upload the data to a billing center. The billing center bills the user for additional time periods during which the DIVX DVD is used. The DIVX system, however, still suffers from the out-of-stock and not-worth-watching problems.

Video-on-demand technology is continually being developed but has not reached a level suitable to mass marketing and deployment. Video streaming over the Internet has video-on-demand like features, but the quality of the presentation is poor. If successfully implemented, a video-on-demand system would overcome several of the limitations of the aforementioned systems. However, due to extremely high bandwidth requirements among other technological hurdles, it may be a long time before the general population has access to video-on-demand.

### SUMMARY OF THE INVENTION

A preferred embodiment of the present invention is a video content distribution system including a portable video content storage device, a publicly located interactive kiosk, and a set-top box. The storage device is preferably configured to hold digitally encoded video content on a nonvolatile storage module, such as a disk drive. The storage device is also preferably configured to be substantially incompatible with industry standard computer systems in its external characteristics, connections, and communication protocols in order to limit illegitimate use.

A user connects the storage device to a publicly located compatible interactive kiosk that stores several encoded programs (hereinafter “content units”), such as feature-length films. The user then selects one or more content units of interest, and the kiosk copies the selections onto the storage device. At home, the user connects the storage device to a compatible set-top box that presents the content units as an output signal to a television set. The set-top box preferably accumulates information (hereinafter “content use data”) related to the use of the video content units, such as how much of a content unit has been viewed and/or how many times it has been viewed. The set-top box then writes the content use data to the storage device. The content use data is preferably read by the kiosk the next time the user connects the storage device to the kiosk. The user can be billed according to the actual use of the content units regardless of how much time has passed since the content units were loaded onto the storage device.

In one embodiment, the storage device can be configured to include decoding and playback capability. Decoded content can be output to a display device. The storage device can also be configured to include a display screen for the display of decoded content.

One aspect of the present invention is a system for distributing video content. The system includes a portable video content storage device upon which digitally encoded video content is securely stored to prevent unauthorized access. The system also includes an interactive kiosk configured to be located in a public location. The kiosk is further configured to receive and access the portable video content storage device. The kiosk is further configured to securely store video content on the portable video content storage device. The system also includes a set-top box configured to receive the portable video content storage device. The set-top box is further configured to access the securely stored video content from the portable video content storage device. The set-top box is further configured to provide the video content as an output signal to a video display. The set-top box can be further configured to write content use data to the portable video content storage device, and the interactive kiosk cam be further configured to read content use data from the portable video content storage device. The portable video content storage device can consists essentially of a passive storage media unit. The encoded video content stored on the storage medium can be encrypted to prevent unauthorized access.

An additional aspect of the present invention is a method of obtaining and using video content. The method includes connecting a portable video content storage device configured for storing digitally encoded video content to an interactive kiosk in a public location. The method also includes selecting video content through the kiosk in order to cause the kiosk to store the video content on the portable video content storage device. The method also includes disconnecting the portable video content storage device from the kiosk. The method also includes connecting the portable video content storage device to a set-top box in a private location. The method also includes causing the set-top box to access, decode, and output as a video signal at least a portion of the selected video content. The method can also include writing content use data to the portable video content storage device. The method can also include reconnecting the portable video content storage device to the kiosk such that content use data written to the portable video content storage device by the set-top box can be read by the kiosk.

An additional aspect of the present invention is a hand-portable secure video content storage device configured for storing digitally encoded video content. The content storage device is further configured to be accessed by a compatible interactive kiosk and a compatible set-top box. The content storage device is further configured to be incompatible with substantially all publicly available electronic devices capable of accessing digitally encoded video content, other than the kiosk and the set-top box.

An additional aspect of the present invention is a hand-held dedicated secure video content storage device. The device includes a mass storage module configured to store at least about an hour of at least television-suitable quality digitally encoded video content. The device also includes a controller configured to prevent unauthorized access to the mass storage module. The controller is further configured to permit video content to be written to the mass storage module by a compatibly configured interactive kiosk. The device also includes a hand-held housing containing the mass storage module and the controller. The device also includes a communication port mounted in the housing. The communication port can be configured to be removably connected to the interactive kiosk to thereby establish communication with the interactive kiosk. The communication port can be an electrical connector. The communication port can be an optical connector. The controller can be configured to authenticate the kiosk. The controller can be further configured to enable video content to be read from the mass storage module by a compatibly configured and authorized set-top box. The mass storage module can be a disk drive. The controller can be further configured to separately limit read and write access to the disk drive. The controller can include a data buffer configured to buffer data as the data is transferred to or from the disk drive. The device can also include stored content use data relating to the use of video content stored on the mass storage module. The controller can be configured to limit access to the mass storage module based at least upon a content rating of a content unit. The controller can be configured to maintain a set of user preferences relating to the format of content units to be stored on the mass storage module.

An additional aspect of the present invention is a hand-portable dedicated video content storage device. The content storage device includes a hard disk drive upon which is stored at least about one hour of at least television-suitable quality digitally encoded video content, wherein the video content has been written to the hard disk drive by an interactive kiosk located in a public location. The content storage device also includes a hand-portable housing configured to contain and protect the disk drive. The content storage device also includes a connector extending through the housing. The connector is configured to extend electrical connections from outside the housing to the hard disk drive. Content use data relating to the use of the stored video content can be stored on the disk drive by a device configured to read the stored video content. The disk drive can be configured such that it is incompatible with industry standard disk drive controllers to prevent unauthorized access. The connector can be configured such that it is incompatible with industry standard connectors to prevent unauthorized access. The video content that is stored on the disk drive can be encrypted to prevent unauthorized access.

An additional aspect of the present invention is a hand-portable removable rewritable media unit upon which is stored at least about one hour of at least television-suitable quality digitally encoded and encrypted video content, wherein the video content has been written to the removable media unit by an interactive kiosk located in a public location. Content use data relating to the use of the stored video content can be stored on the removable media unit. The content use data may be digitally signed to prevent tampering. The removable media unit can be a rewritable magnetic media disc. The removable media unit can be a rewritable optical media disc.

An additional aspect of the present invention is a set-top box for accessing video content stored on a portable video content storage device. The set-top box includes a receptacle configured to receive the portable video content storage device, wherein the portable video content storage device can be inserted and removed by a user. The set-top box also includes a video decoder module configured to decode the video content to produce an output signal. The set-top box also includes a processor configured to control the video decoder module. The processor is further configured to accumulate content use data based at least upon an amount of use of the video content and to store the accumulated content use data on the portable video content storage device. The processor can be further configured to control the portable video content storage device. The set-top box can also include a decryption module configured to decrypt encrypted video content. The set-top box can also include a translation module configured to translate a nonstandard communications protocol used by the portable video content storage device into an industry standard communications protocol. The set-top box can also include an authentication module configured to provide authentication information to the portable video content storage device. The output signal can include video information and audio information. The processor can be further configured to access user preferences stored on the portable video content storage device. The processor can be further configured to modify the user preferences. The processor can be configured to limit access to a content unit stored on the portable video content storage device based at least upon a content rating of the content unit.

An additional aspect of the present invention is an access unit for accessing data stored on a hand-portable dedicated secure video content storage device. The access unit includes a receptacle configured to receive the content storage device. The access unit also includes a controller configured to access the content storage device. The controller includes an authentication module configured to provide authentication information to the content storage device to thereby obtain access to data stored on the device. The controller can also include a translation module configured to translate data transferred between the access unit and the content storage device. The translation module can include a decryption module configured to decrypt data obtained from the content storage device. The translation module can be configured to translate a nonstandard communications protocol used by the storage device into an industry standard communications protocol.

An additional aspect of the present invention is a method of presenting video content and providing information related to the use of the video content. The method includes receiving in a user accessible receptacle a portable video content storage device storing video content. The method also includes reading a portion of the video content from the portable video content storage device. The method also includes presenting the portion of the video content. The method also includes accumulating present content use data. The method also includes transferring the present content use data onto the portable video content storage device. The method can also include reading prior content use data from the portable video content storage device and amending the prior content use data to incorporate the present content use data. The method can also include transferring the amended content use data onto the portable video content storage device. The content use data can include a listing of executed user commands. The content use data can associate a number of uses with a portion of the video content.

An additional aspect of the present invention is a method of accessing video content stored on a portable video content storage device. The method includes receiving a portable video content storage device in a set-top box. The method also includes establishing communication between the portable video content storage device and the set-top box. The method also includes performing an authentication of the set-top box by the portable video content storage device. The method also includes transferring a portion of the video content from the portable video content storage device to the set-top box.

An additional aspect of the present invention is an interactive kiosk for distributing content through a portable video content storage device. The interactive kiosk includes a display for displaying information to the user. The interactive kiosk also includes an input device for receiving input from the user. The interactive kiosk also includes a receptacle configured to receive the portable video content storage device. The interactive kiosk also includes a content mass storage module for storing a library of available video content. The interactive kiosk also includes a processor configured to control the kiosk so as to allow a user to copy video content onto the portable video content storage device. The processor is further configured to read content use information from the portable video content storage device. The interactive kiosk also includes a secure housing configured to be located in a public location. The interactive kiosk can also include a content input module configured to receive new video content via a satellite link. The interactive kiosk can also include an authentication module configured to authenticate the video content storage device. The processor can be further configured to read user preferences from the portable video content storage device. The user preferences can include a content rating limitation. The user preferences can include a preferred content format. The processor can be further configured to enable a user to delete video content from the portable video content storage device.

An additional aspect of the present invention is a method for providing video content. The method includes receiving from a user, in an interactive kiosk in a public location, a portable video content storage device capable of storing video content. The method also includes establishing communication with the storage device. The method also includes presenting to the user a menu of available video content. The method also includes receiving from the user a selection from the available video content. The method also includes copying the selected video content to the storage device. The method can also include reading content use information from the storage device.

An additional aspect of the present invention is a method for providing and monitoring the use of video content. The method is performed by an interactive kiosk located in a public location. The method includes receiving a portable video content storage device in a receptacle. The method also includes presenting to the user a menu of available video content. The method also includes receiving from the user a selection from the available video content. The method also includes writing the selected video content to the portable video content storage device. The method also includes again receiving the portable video content storage device in the receptacle. The method also includes reading data from the portable video content storage device related to the use of the selected video content. The method can also include reading a set of user preferences from the storage device. The method can also include limiting the menu of video content presented to the user based at least upon the set of user preferences. The method can also include identifying a format in which to write video content to the storage device based at least upon the set of user preferences. The method can also include overwriting video content stored previously on the portable video content storage device. The method can also include deleting video content stored previously on the portable video content storage device.

An additional aspect of the present invention is a portable video content player. The player includes a mass storage module configured to store at least about an hour of at least television-suitable quality digitally encoded video content. The player also includes a video decoder module configured to decode the video content. The player also includes a processor configured to control the video decoder module and the mass storage module. The processor is configured to create content use data based upon the use of the video content. The player also includes a hand-held housing containing the mass storage module, the video decoder module, and the processor. The player can also include a communication port mounted in the housing. The communication port can be configured to be removably connected to an external device whereby video content can be transferred from the external device to the mass storage module. The external device can be an interactive kiosk located in a public location through which a user can select video content to be transferred to the video content player. The external device can be a personal computer. The processor can be further configured to prevent unauthorized access to the mass storage module. The processor can be further configured to permit video content to be written to the mass storage module by a compatibly configured interactive kiosk. The player can also include a decryption module configured to decrypt encrypted video content. The player can also include a display for displaying decoded video content. The display can be attached to the hand-portable housing. The player can also include a user input device through which the decoding of video content can be controlled. The player can also include an infrared remote control receiver through which a user can control the player using an infrared remote control. The player can also include a power source. The video decoder can provide an output signal comprising a video signal and an audio signal. The player can also include a video output port for providing the video signal to an external display device and an audio output port for providing the audio signal to an external audio device. The player can also include an identity verification module configured to verify the identity of a user. The identity verification module can be a fingerprint reader.

### BRIEF DESCRIPTION OF THE DRAWINGS

FIG. 1A illustrates a configurational overview of a preferred embodiment of the present invention;

FIG. 1B illustrates a procedural overview of the present invention;

FIG. 2 illustrates a preferred embodiment of a system for operating several kiosks;

FIG. 3A illustrates a functional block diagram of an embodiment of a portable storage device;

FIG. 3B illustrates a preferred embodiment of the portable storage device;

FIG. 3C illustrates a first alternative embodiment of the storage device in conjunction with a kiosk or a set-top box;

FIG. 3D illustrates a second alternative embodiment of the storage device in conjunction with the kiosk or the set-top box;

FIG. 3E illustrates a third alternative embodiment of the storage device that can be used without a set-top box;

FIG. 3F illustrates a system in accordance with which video content can be uploaded to the storage device from a personal computer;

FIG. 4 illustrates a preferred embodiment of the kiosk;

FIG. 5A illustrates a method performed by the kiosk during a transaction with a user;

FIG. 5B illustrates a method by which the kiosk obtains new content units for distribution;

FIG. 6 illustrates a preferred embodiment of the set-top box;

FIG. 7A illustrates a first embodiment of the content use data;

FIG. 7B illustrates a second embodiment of the content use data;

FIG. 8 illustrates a method performed by the set-top box in displaying content units;

FIG. 9A illustrates a preferred embodiment of a storage device access unit; and

FIG. 9B illustrates an alternative embodiment of the access unit.

### DETAILED DESCRIPTION OF THE EMBODIMENTS

In the following description, reference is made to the accompanying drawings, which form a part hereof, and which show, by way of illustration, specific embodiments or processes in which the invention may be practiced. Where possible, the same reference numbers are used throughout the drawings to refer to the same or like components. In some instances, numerous specific details are set forth in order to provide a thorough understanding of the present invention. The present invention, however, may be practiced without the specific details or with certain alternative equivalent devices and methods to those described herein. In other instances, well-known methods and devices have not been described in detail so as not to unnecessarily obscure aspects of the present invention.

I. Overview

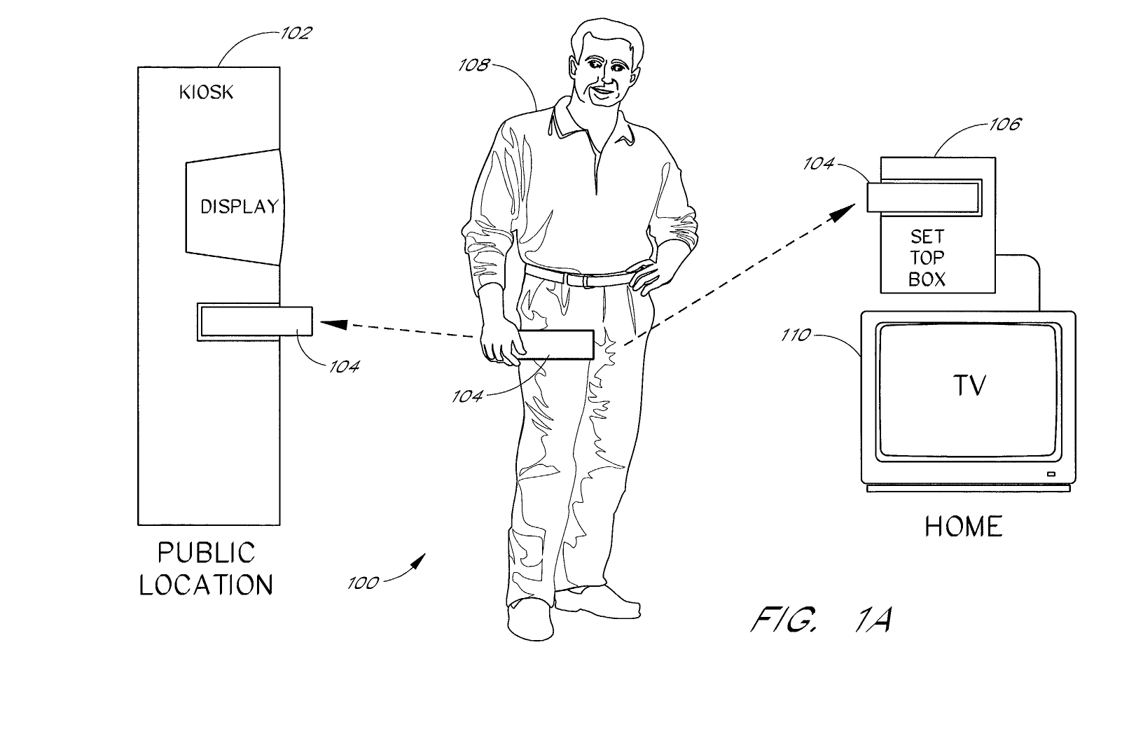

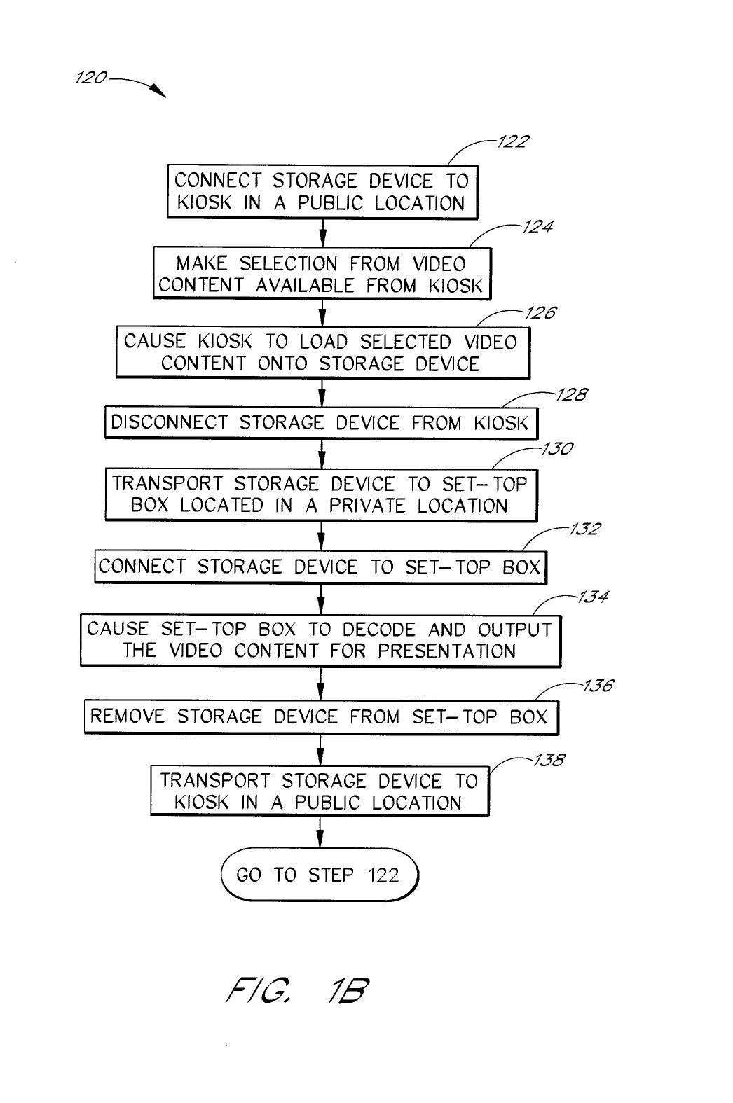

FIGS. 1A-B illustrate an overview of one embodiment of the present invention. As shown in FIG. 1A, a video content distribution system 100 includes a kiosk 102 located in a public location, a portable video content storage device 104, and a set-top box 106, preferably located in a private location such as a user's home. The storage device 104 is preferably sized to be hand-portable and includes a storage module capable of storing video content, such as a disk drive. The kiosk 102 preferably stores a much larger amount of video content than the storage device. FIG. 1B illustrates a method 120 in accordance with which the system 100 can be used.

At a first step 122 of the method 120, the user 108 places the storage device 104 in a receptacle on the kiosk 102. At a step 124, the user 108 makes a selection from the video content stored on and made available through the kiosk 102. At a step 126, the user instructs the kiosk 102 to copy the selected video content onto the storage device 104. Once the content has been copied onto the storage device 104, the user 108 removes the storage device 104 from the kiosk 102 at a step 128, and transports it to the location of the set-top box 106 at a step 130. The user 108 then places the storage device 104 in a receptacle on the set-top box 106 at a step 132. At a step 134, the user causes the set-top box 106 to read the video content from the storage device 104. The set-top box 106 decodes the video content, and outputs the video content for presentation, preferably on a television 110 or other video display device. At a step 136, the user 108 removes the storage device 104 from the set-top box 106. The user 108 transports the storage device 104 to a kiosk 102 at a step 138. The kiosk in the step 138 may be the same kiosk or a different kiosk than the kiosk to which the storage device 104 was previously connected in the step 122. At the completion of the step 138, the method 120 is again repeated.

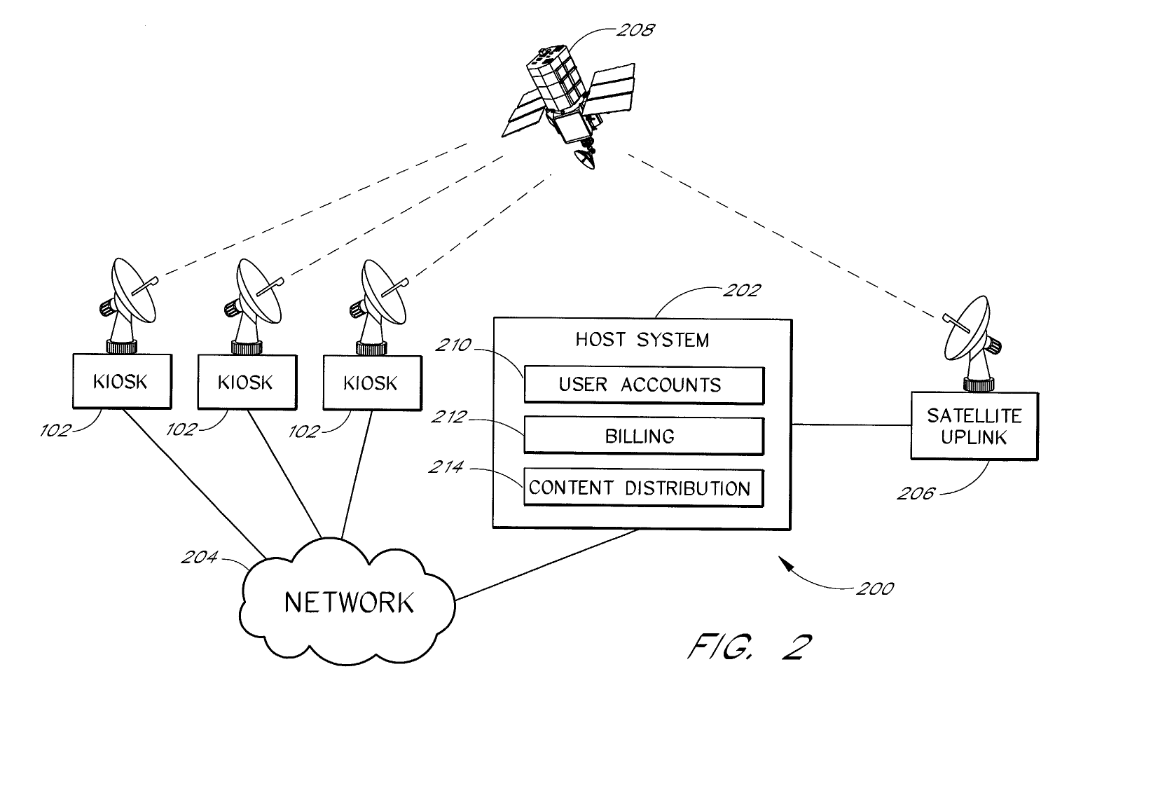

FIG. 2 illustrates a preferred embodiment of a system 200 for operating several kiosks 102. The kiosks 102 are connected to a host system 202 through a communications network 204, such as the Internet. The host system 202 preferably manages and coordinates user accounts, billing for content usage, and content distribution to the kiosks 102 through associated modules 210, 212, and 214. The modules 210, 212, and 214 of the host system 202 may include one or more computer systems that that may be co-located or separately located.

The host system 202 preferably communicates with a satellite uplink 206 to coordinate the transmission of encoded video content via a satellite 208 to the kiosks 102, which are preferably equipped with satellite dishes. The host system 202 preferably relays information regarding the timing of the transmissions via the communications network 204. The host system 202 may also relay any other instructions necessary for the kiosks 102 to operate properly through either the satellite connection or the network 204. In order to bill users 108 for the use of the content, the kiosks 102 preferably communicate content use data to the host system 202 through the network 204. Alternatively, the kiosks 102 can transmit information back to the host system 202 via the satellite 208 by providing a bi-directional satellite link.

II. The Portable Video Content Storage Device

A. Functional Description

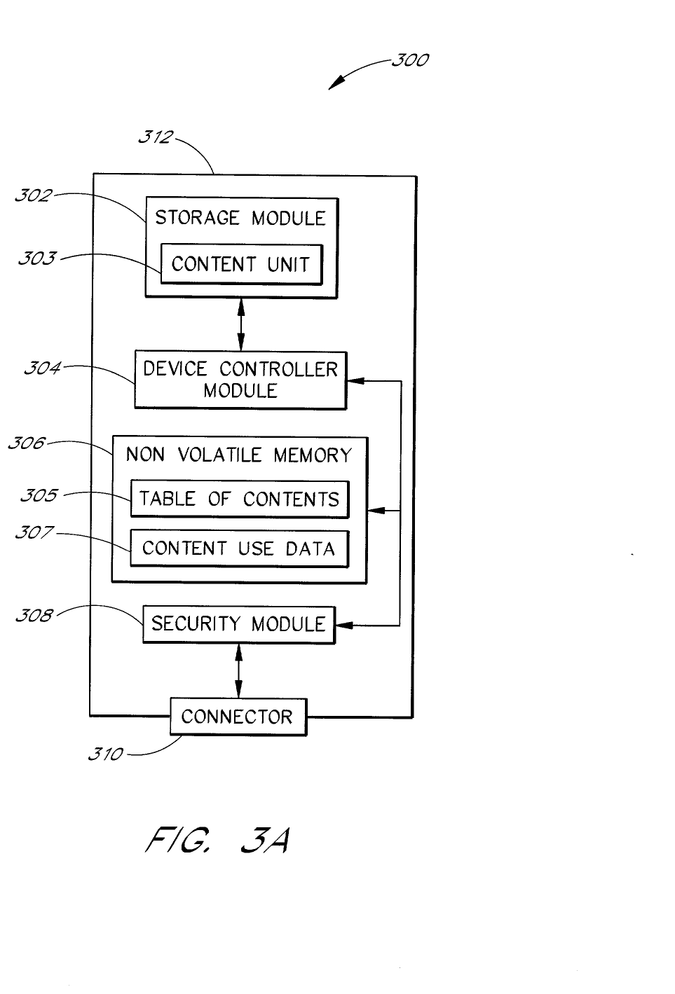

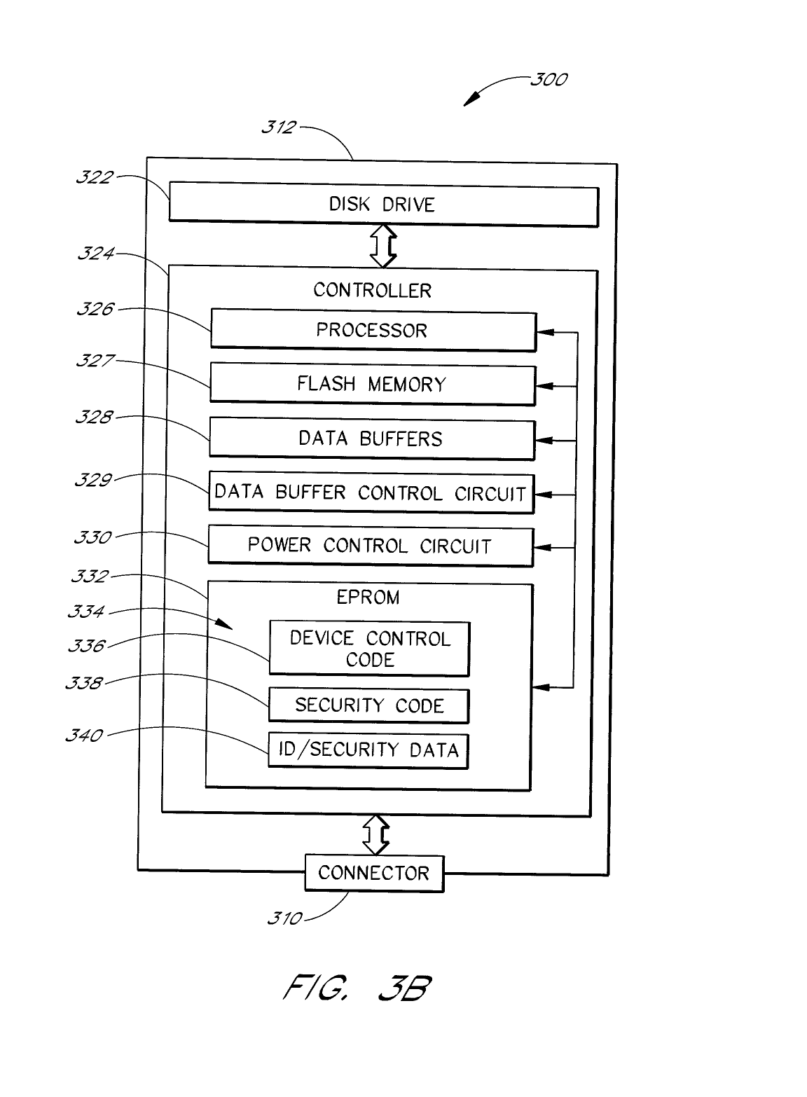

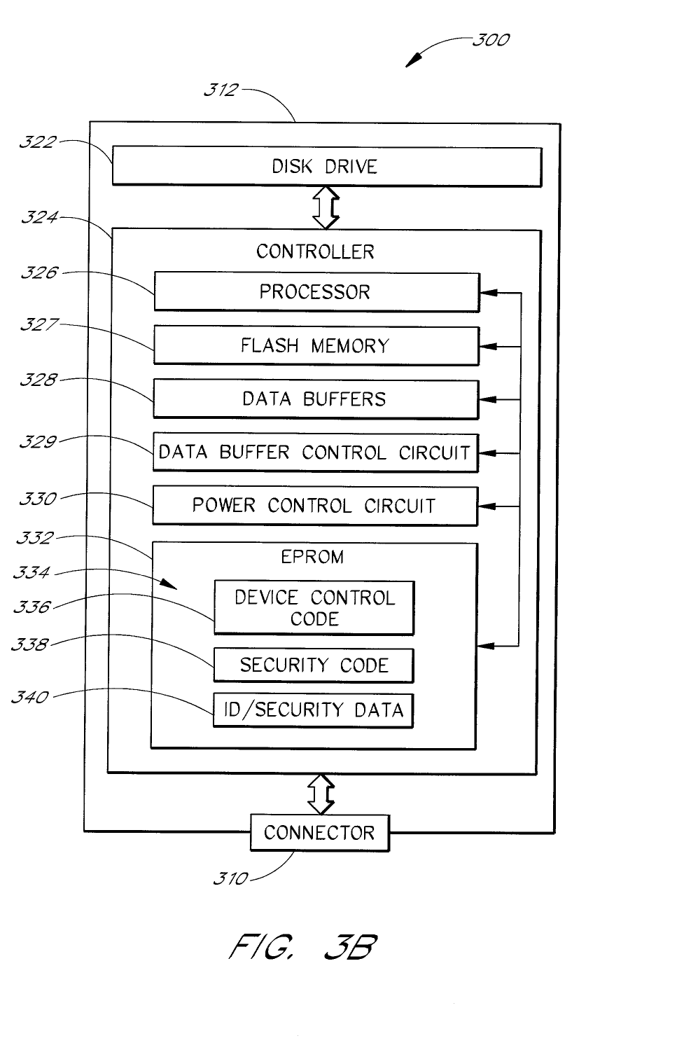

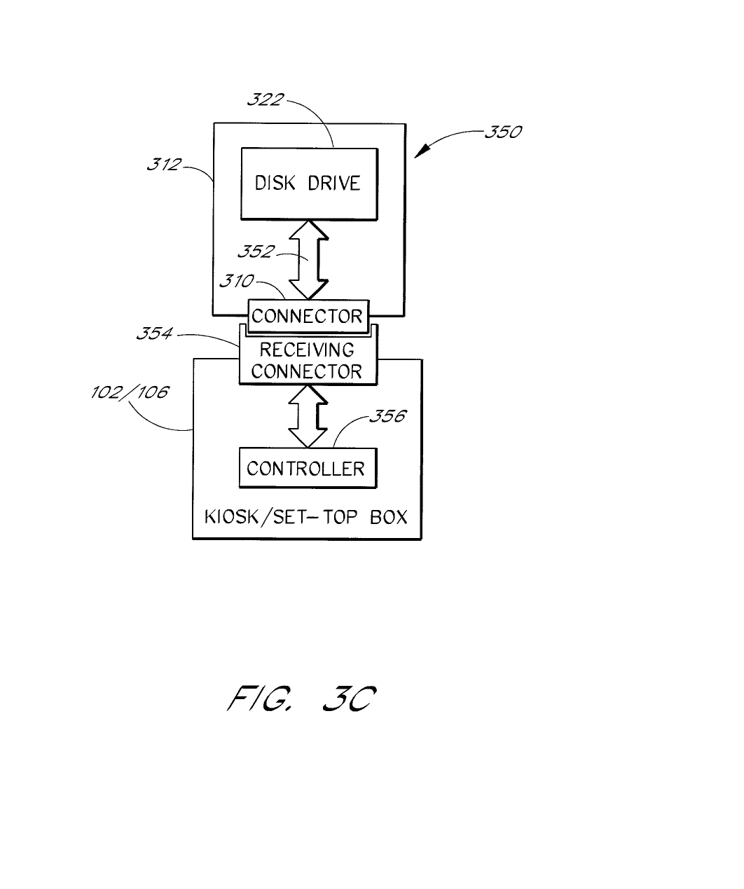

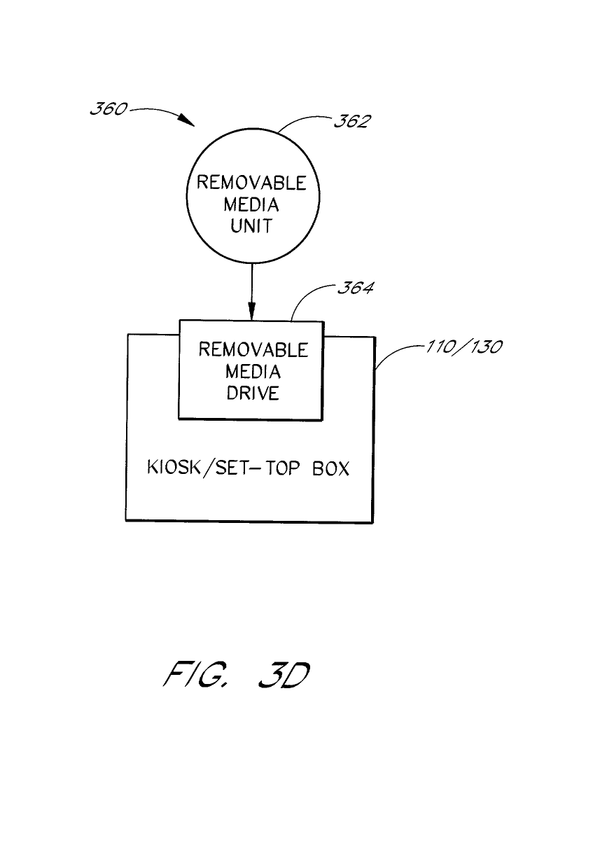

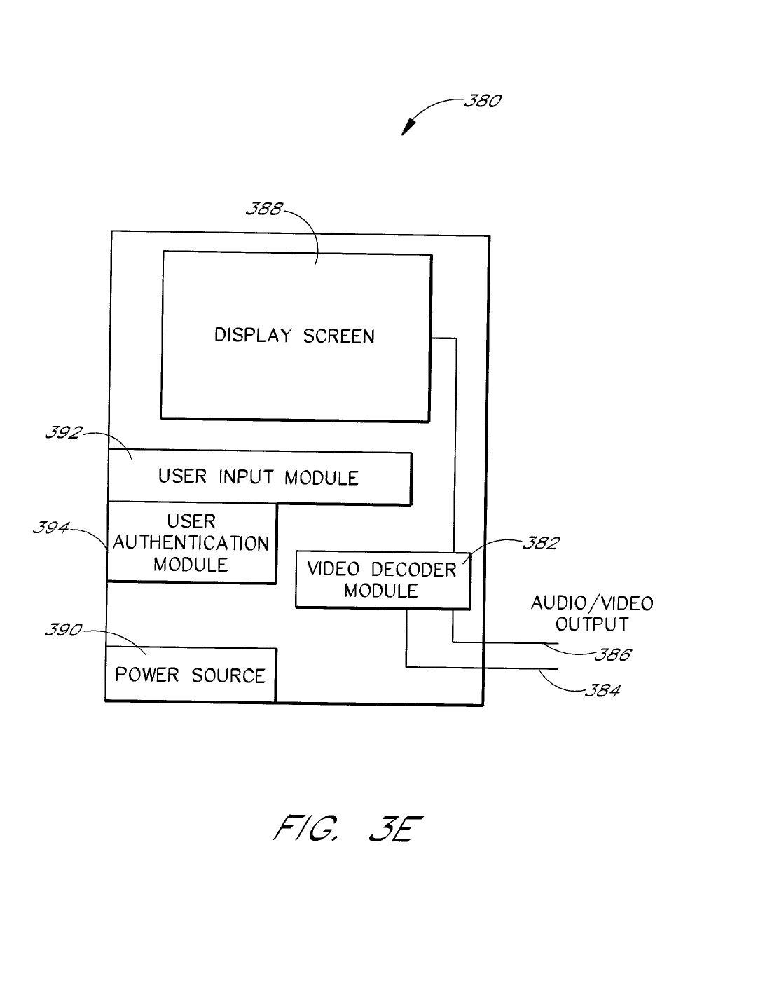

FIG. 3A illustrates a functional block diagram of a preferred embodiment of the portable storage device 300. The storage device 300 preferably includes the following functional components: a nonvolatile mass storage module 302, a device controller module 304, a nonvolatile memory 306, a security module 308, a connector 310, and a housing 312. The storage device 300 preferably derives operating power from the kiosk 102 or the set-top box 106 through the connector 310 and thus does not require a separate power source such as a battery. The storage device 300 may, however, include its own power source.

The storage device 300 can be made conveniently hand-portable as opposed to general purpose devices such as laptop computers, since various components, such as a keyboard, a battery, or a floppy disk drive, need not be included.

The nonvolatile mass storage module 302, which is preferably a hard disk, is used to store video content. When MPEG-2 compression is used, movie-length digital video representations typically occupy about 3 to 4 gigabytes of storage space. Each independent video program or representation will be referred to as a content unit 303. The mass storage module 302 preferably has a storage capacity of at least 12 to 16 gigabytes to allow several movie-length content units to be stored simultaneously. Alternatively, the mass storage module 302 may have a smaller storage capacity.

The device controller module 304 controls and functions as an interface to the storage module 302, providing any logic and control functions necessary to drive the module 302. The device controller module 304 preferably includes any functionality necessary to control the disk drive such as is included in typical disk drive controllers. The device controller module 304 is preferably implemented by a combination of a processor and code that is executed by the processor. The device controller module 304 may alternatively be implemented as an application specific integrated circuit. The device controller module 304 preferably also includes buffers to buffer data as it is transferred to or from the storage module 302. In an alternative embodiment, the storage module 302 and the device controller 304 may be integrated into a single module. In still other embodiments, the technology used to implement the storage module 302 may make the device controller module 304 unnecessary. The use of Flash memory, for example, may make the device controller module 304 unnecessary.

The nonvolatile memory 306 is preferably Flash memory and preferably stores a table of contents 305 listing the content units 303 stored on the storage device 300. The nonvolatile memory 306 preferably also stores content use data 307. Content use data 307 includes information related to the use of the video content units (such as how much of a content unit 303 has been viewed and/or how many times it has been viewed). The content use data 307 may alternatively be stored on the storage module 302. Content use data 307 will be described in further detail in subsection IV-B below.

The nonvolatile memory 306 may also be used to store temporary data or information that may be conveniently accessed without accessing the storage module 302. The temporary data may also include the following, for example: a table of content units stored on the disk drive; menus to be displayed by the set-top box 106 (listing, for example, the available content units); limitations and/or instructions for the set-top box 106 regarding the use of the content units (allowing, for example, the content unit 303 to be played only once or not allowing fast forwarding during certain portions of the content unit 303); and interactive programs that can be executed by the set-top box (programs, for example, making special offers, offering discounts, or soliciting responses from the user 108).

The security module 308 provides functionality that limits illegitimate access to the device controller module 304, the nonvolatile memory 306, and the storage module 302. The security module 308 preferably acts as a gateway for access to the data stored on the storage device 300 by authenticating the identity of any device that attempts to communicate with the storage device 300 before communication is allowed. The security module 308 preferably uses security technology such as public-private (asymmetric) key encryption/authentication, which is well known in the art, to authenticate any device attempting to communicate with the storage device 300. The security module 308 preferably controls access and power to the storage module 302. The security module 308 may also be configured to separately control read and write access to the storage module 302.

The security module 308 preferably implements a non-standard communication protocol that the storage device 300 uses to communicate with either the kiosk 102 or the set-top box 106. Accordingly, the communication protocol used by the storage device 300 is configured to be substantially incompatible with all industry standard devices and computer systems other than the kiosk 102 and the set-top box 106. The protocol used may include, for example, different handshaking, command fields, data fields, or bit assignments than industry standard protocols. The security module 308 is preferably implemented by a combination of a processor and code that is executed by the processor. The security module 308 may alternatively be implemented as an application specific integrated circuit.

The connector 310 provides a communication port or pathway between the storage device 300 and the kiosk 102 or the set-top box 106. The connector 310 is preferably an electrical connector that carries electrical signals into and out of the storage device 300. The connector 310 may alternatively or additionally include an optical link. The housing 312 is preferably configured to be easily portable by hand (e.g. 6 inches×4 inches×2 inches, 3 inches×3 inches×1 inches, or smaller in size). The housing 312 is also preferably configured to be rugged and resistant to contamination.

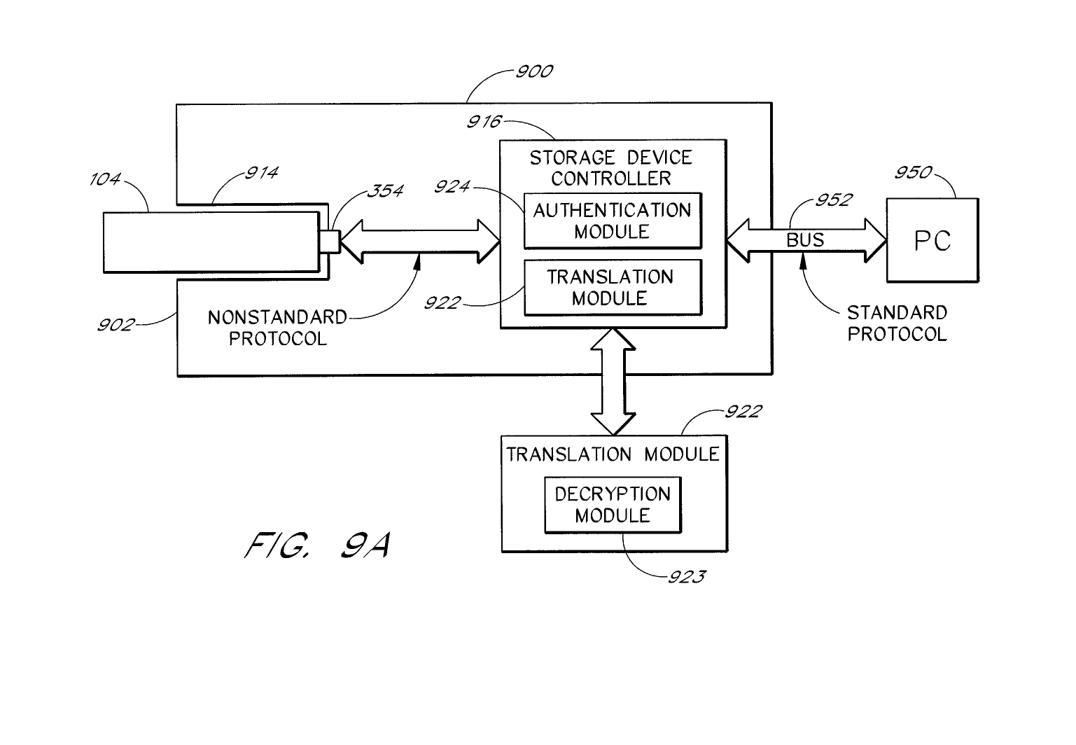

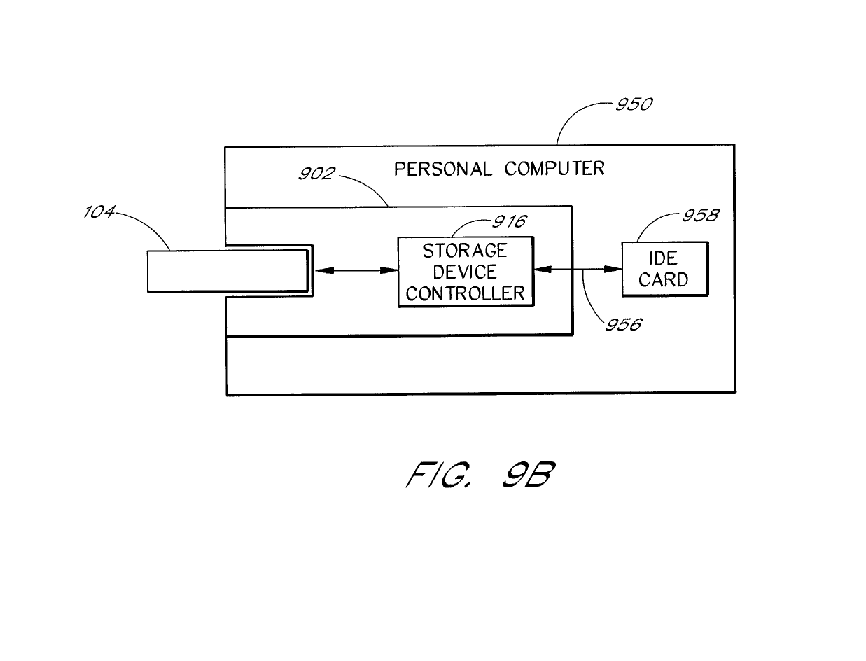

The connector 310 and the housing 312 are also preferably configured such that the storage device 300 is substantially incompatible with all industry standard devices and computer systems other than the kiosk 102, and the set-top box 106. For example, the connector 310 may have a different pin gauge, a different shape, or different keying than industry standard connectors. In this manner, illegitimate use of the content stored on the storage device 300 can be limited. The storage device 300 may, however, be configured to be compatible with certain test and set-up equipment such as the storage device access unit 900 (FIG. 9) described in section V below. Access to the test and set-up equipment is preferably restricted to trusted, legitimate entities such as sellers and service providers that operate kiosk video distribution systems 200 (FIG. 2).

The connector 310 should be designed to withstand several thousands of connections and disconnections. The industry standard Device Bay specification (www.device-bay.org) identifies connectors that meet these duty requirements. Device Bay type connectors can be custom manufactured such that they are incompatible with the standard, but still meet the duty requirements.

In one embodiment, the storage device 300 can maintain a set of user preferences. In one embodiment, the user preference can be adjusted through the kiosk 102 or the set top box 106 using interactive menus. Alternatively, preferences can be adjusted through user controls that can be incorporated into the device 300 itself.

The user preferences can include a ratings field that allows only movies or content of certain content ratings (e.g., G, PG, R) to be stored on the storage device by a kiosk. Additionally, the ratings field may allow only certain ratings of content to be read from the storage device although other ratings of content may also be stored on it. The modification of the ratings preference can be protected by a password so that only certain users can modify the ratings control.

The user preferences may also include preferred formats in which content is to be stored on the device by a kiosk. The formats can specify aspect ratio (e.g., wide-screen, letter-box, 4 to 3 aspect ratio); quality of the video (HDTV, high, medium, low); quality of the audio (stereo, surround sound, high, medium, low); closed captioning; and dubbed foreign language options, for example.

One skilled in the art will recognize that the storage device 300 need not necessarily include all of the functional components illustrated in FIG. 3A and described in this subsection. As already mentioned, the device controller module 304 need not be included if the storage module 302 uses technology that does not require it. The nonvolatile memory 306 need not be included, as the information stored in the nonvolatile memory 306 may alternatively stored on the storage module 302 or not stored at all. The security module 308 need not be included when the incompatibility of the connector 310 and housing 312 with industry standards are relied upon for security. Alternatively, security may be achieved by encrypting the content and data stored on the storage device 300 before the data is placed on the storage device 300. The content and data can then be decrypted after it is read from the storage device 300.

B. Components of the Storage Device

FIG. 3B illustrates several components of a preferred embodiment of the storage device 300. The storage device 300 includes a disk drive 322, a controller 324, and the connector 310, all of which are contained by the housing 312. The controller 324 is preferably connected to the disk drive 322 and the connector 310.

The disk drive 322 corresponds to the storage module 302 (FIG. 3A). Several suitable disk drives are presently commercially available in 2½ and 3½-inch sizes. In alternative embodiments, the mass storage module 302 may be implemented using alternative technology such as an optical disk or Flash memory as technological advances yield suitable portable and cost effective implementations.

Industry standard disk drives and controllers are often manufactured as a single, integrated unit. These integrated units provide a specifically defined set of control registers, which are mapped to predetermined addresses. The units recognize command and bit definitions for data written to and read from the control registers. The most commonly used definition is specified by the IEEE ATA standard and its variations, also known as IDE. Typical personal computer IDE controllers rely on the precise format of this definition to control and communicate with a disk drive. In one embodiment, the disk drive 322 and controller 324 are custom manufactured such that the integrated unit does not conform to industry standard configurations, such as IDE or SCSI. This feature makes illegitimate access to the data on the disk drive 322 more difficult. The disk drive 322 and the controller 324 can be configured in several other ways such that they do not conform to industry standards. For example, the disk 322 can be formatted in a nonstandard configuration or the disk 322 and controller 324 can be configured to use a nonstandard file structure.

The functionality of the device controller module 304, the nonvolatile memory 306, and the security module 308 of FIG. 3A are preferably incorporated in the controller 324. The controller 324 preferably includes: a processor 326, Flash memory 327, one or more data buffers 328, a data buffer control circuit 329, a power control circuit 330, and an erasable programmable read only memory (EPROM) 332. The processor 326 is preferably connected to all of the other components in the controller 324. The Flash memory 327 corresponds to the nonvolatile memory 306 (FIG. 3A). The data buffers 328 buffer data to and from the disk drive 322. The data buffer control circuit 329 controls the operation of the data buffers 328. The power control circuit 330 controls power to the disk drive 322. The processor 326 preferably executes code 334 stored in the EPROM 332.

The code 334 preferably comprises device control code 336 and security code 338, in addition to any other code that may be necessary to control the functionality of the storage device. The device control code 336 causes the processor 326 to provide the functionality of the device controller module 304 (FIG. 3A). The security code 338 causes the processor 326 to provide the functionality of the security module 308 (FIG. 3A).

The EPROM 332 preferably also stores an ID and security data block 340. The ID and security data block 340 preferably includes an identification code (ID) by which the storage device 300 may be identified. The ID and security data block 340 may also include one or more security keys that the processor 326 can use to transact secure communications. A read only memory (ROM), programmable read only memory (PROM), or electronically erasable programmable read only memory (EEPROM) may be used in place of the EPROM 332.

The data buffers 328 preferably lie in a data path between the disk drive 322 and the connector 310. The data buffers 328 function to buffer data as the data is written to or read from the disk drive 322. The processor 326 may have read, write, and control access to the data buffers.

The processor 326 preferably has control connections to the power control circuit 330 and the data buffer control circuit 329. The power control circuit 330 preferably controls power to the disk drive 322. The data buffer control circuit 329 controls the operation of the data buffers, effectively turning them on or off in order to control access to the data on the disk drive 322. The data buffer control circuit 329 preferably also has control over the direction of data flow through the buffers 328. Accordingly, the data buffer control circuit 330 can control whether only read access, only write access, both read and write access, or no access is permitted to the disk drive 322.

In one embodiment, the entire controller 324 is implemented on a single integrated circuit (IC). Therefore, the ID and security data block 340 is stored on the same IC that contains the processor 326. In this configuration, security is increased since the storage device ID need not be imported to the IC and the security keys need not be exported from the IC. Accordingly, it would be impossible to replace the EPROM 332 with another one to illegitimately use the storage device 300.

C. First Alternative Embodiment of the Storage Device

FIG. 3C illustrates a first alternative embodiment 350 of the storage device 104 in conjunction with the kiosk 102 or the set-top box 106. The first alternative embodiment 350 preferably includes the disk drive 322, the connector 310, and the housing 312. In contrast to the preferred embodiment 300 however, this embodiment 350 need not include a processor or controller.

The connector 310 preferably interfaces with a receiving connector 354 when the storage device 350 is inserted into either the kiosk 102 or the set-top box 106. The connector 310 includes leads 352 that connect to the disk drive 322 and pass signals directly to the disk drive 322. The receiving connector 354 passes signals from the connector 310, preferably to a disk drive controller 356 that is located in either the kiosk 102 or the set-top box 106 as opposed to in the storage device 350. The connector 310 and the receiving connector 354 are configured for and capable of carrying signals typically exchanged between a disk drive and a disk drive controller.

The storage device 350 preferably does not incorporate any of the functionality of the device controller module 304, the nonvolatile memory 306, or the security module 308. The functionality of these modules is substantially offloaded to the kiosk 102 and to the set-top box 106. Accordingly, the first alternative embodiment 350 is less expensive and simpler to design and manufacture than the embodiment illustrated in FIG. 3B. In the first alternative embodiment 350, the functionality of the device controller 304 is handled by the disk drive controller 356 in the kiosk 102 or in the set-top box 106. The data that would be stored in the nonvolatile memory 306, such as the content use data 307, can be instead stored directly on the disk drive 322 by the kiosk 102 or the set-top box 106.

The storage device 350 may be configured to be compatible or incompatible with industry standard systems. Increased security can be achieved by using incompatible units. In order to make the storage device 350 incompatible with industry standard systems, the disk drive 320 can be formatted in a nonstandard fashion or it may be configured to use a nonstandard file structure. Industry standard technology may, however, be substantially less expensive. In either case, the objective of the security module 308 can be substantially achieved by encrypting the content and data stored on the storage device 350 before the data is placed on the storage device 350. The content and data can then be decrypted after it is read from the storage device 350.

D. Second Alternative Embodiment of the Storage Device

FIG. 3D illustrates a second alternative embodiment 360 of the storage device 104 in conjunction with the kiosk 102 or the set-top box 106. The storage device 360 in the second alternative embodiment is a removable media unit 362, preferably including a passive storage medium (e.g., magnetic or optical media that does not include any active componentry/circuits). The removable media unit 362 may be a removable magnetic or optical disk or cartridge, such as a CD-RW disc. The removable media unit 362 is accessed by a removable media drive 364 that is located in either the kiosk 102 or the set-top box 106. The removable media unit 362 is preferably a rewritable unit (data can be erased and rewritten as on a disk drive). Alternatively, the removable media unit 362 may be a write-once unit (data can be written, but not erased as on recordable CDs).

Like the first alternative embodiment of the storage device 350, the second alternative embodiment 360 preferably does not incorporate any of the functionality of the device controller module 304, the nonvolatile memory 306, or the security module 308. Also, like the first alternative embodiment 350, the storage device 360 may be configured to be compatible or incompatible with industry standard drives. The objective of the security module 308 can be substantially achieved by encrypting the content and data stored on the storage device 360 before the data is placed on the storage device 360. The content and data can then be decrypted after it is read from the storage device 360.

The removable media unit 362 can be any type of removable media capable of storing video content. The removable media unit 362 preferably stores at least 3 to 4 gigabytes of data in order to hold a feature-length movie, but the unit 362 may store less data by using lower quality video or by storing less content. Iomega presently offers a 2-gigabyte removable cartridge drive, called the Jaz® drive, which, with its cartridge, can be used as the removable media drive 364 and the removable media unit 362. The Jaz drive is a rewritable unit that functions like a hard disk drive, with an advertised 4.9 MB/sec minimum sustained transfer rate. At this transfer rate, it would take approximately 5 minutes to load about 45 minutes (1.65 gigabytes) of MPEG-2 video onto the drive. If the trend of recent advances in storage continues, substantially greater capacities and transfer rates will soon be available using removable media. For example, CD-RW, DVD-RW, and DVD+RW are rewritable optical technologies, capable of storing up to 5 gigabytes on a CD-size disk, which can also be used. CD-R and DVD-R are optical write once-technologies that can also be used.

Regardless of whether rewritable or write-once technology is used, data that would otherwise be stored in the nonvolatile memory 306 can be instead stored directly on the removable media unit 362 by the kiosk 102 or the set-top box 106.

E. Third Alternative Embodiment of the Storage Device

FIG. 3E illustrates a third alternative embodiment of the storage device 380 configured to be operated as a video content player without a set-top box 106. In this embodiment, some or all of the functionality, functional components, and features of the set-top box 106, which are described in Section IV below, can be incorporated into the storage device 380. Accordingly, the storage device can be connected directly to a television set and a separate set-top box 106 need not be used. This embodiment of the storage device 380 preferably also includes some or all of the components described in Subsection A above with reference to FIG. 3A.

As illustrated in FIG. 3E, the storage device 380 can include a video decoder module 382 and audio 384 and video 386 output ports. The decoder module 382 and output ports 384, 386 can be configured to supply video and audio separately or together in one or more possible formats. Some formats can include headphone-level audio, composite video, S-video, and a standard RF television signal via a coaxial cable connector. Various presentation devices, such as, for example, a video monitor, a television, video glasses, headphones, and/or a digital picture frame can be connected to the output ports 384, 386 in order to render video and/or audio content.

The storage device can also be configured to include a small display 388 upon which video output can be displayed. The display can be implemented using a small liquid crystal matrix display. A user can connect headphones to the audio output port 384 and use the storage device as a portable video watching device.

The storage device can be configured to include its own power source 390, such as a battery or an internal or external AC power adapter. Alternatively, the storage device can be powered by a set top box or kiosk.

The storage device 380 can also include a user input module 392 through which the user can operate the device. The user input module 392 can include controls, such as buttons, keys, and/or a touch sensitive screen through which user input can be received. The user input module 392 may alternatively or additionally include an infrared remote control receiver through which commands from an infrared remote control can be received. Feedback can be provided to the user through the display screen 388, through the video output 386 to be displayed on a presentation device, and/or through another display, such as a small liquid crystal display.

In one embodiment, the storage device 380 can be configured to include a user authentication module 394 through which the device can authenticate a user. The authentication module 394 may be, for example, a fingerprint reader, a digitally encoded key card swipe, or other user identification device. The authentication module 394 can be used to deter theft of the storage device 380 and to limit the user of the device to certain identified persons.

The storage device 380 can also be configured to use a set-top box 106 as a pass-through device. In this configuration, the set-top box can have limited functionality and primarily just supply power to the storage device 380 and pass output signals through to a rendering device, such as a television. The storage device 380 can be configured with one connector that includes power pins and all of the interface signals. The set top box can provide power and pass the interface signals through to corresponding coaxial, S-video, or composite output connectors from the storage device 380.

In one embodiment, the mass storage module 302 of the storage device 380 can be configured to be replaceable and removable from the storage device. In the case a hard disk drive is used, the drive can be mounted in the storage device such that it can be easily replaced by the user with a larger capacity drive. Alternatively, a removable storage cartridge, such as, for example, a Jaz® drive and cartridge or a DVD-RAM drive and cartridge could be used as the mass storage module 302. To ensure security, the content placed on the cartridge can be encrypted.

As illustrated in FIG. 3F, the storage device 380 can also be configured such that it may be connected to and accessed through a regular desktop personal computer 396. A USB or Firewire connection, for example, can be used to connect the storage device 380 to the computer 396. The storage device 380 can be configured such that the desktop computer 396 can upload video content to the storage device 380.

In accordance with this embodiment, the controller 324 can be configured to separately and/or securely maintain any content or data that has been written to the storage device 380 by a kiosk 102, so that this kiosk data inaccessible through the personal computer 396. This may be accomplished through disk partitioning and/or encryption of data to be protected.

In one embodiment, video content loaded onto the storage device by the personal computer 396 can also be decoded and output, similar to content obtained from a kiosk. In one embodiment, the storage device 380 need not incorporate the security features and compatibility with a kiosk and may be used solely to decode and output video content uploaded from a personal computer 396.

III. The Kiosk

A. Kiosk Components

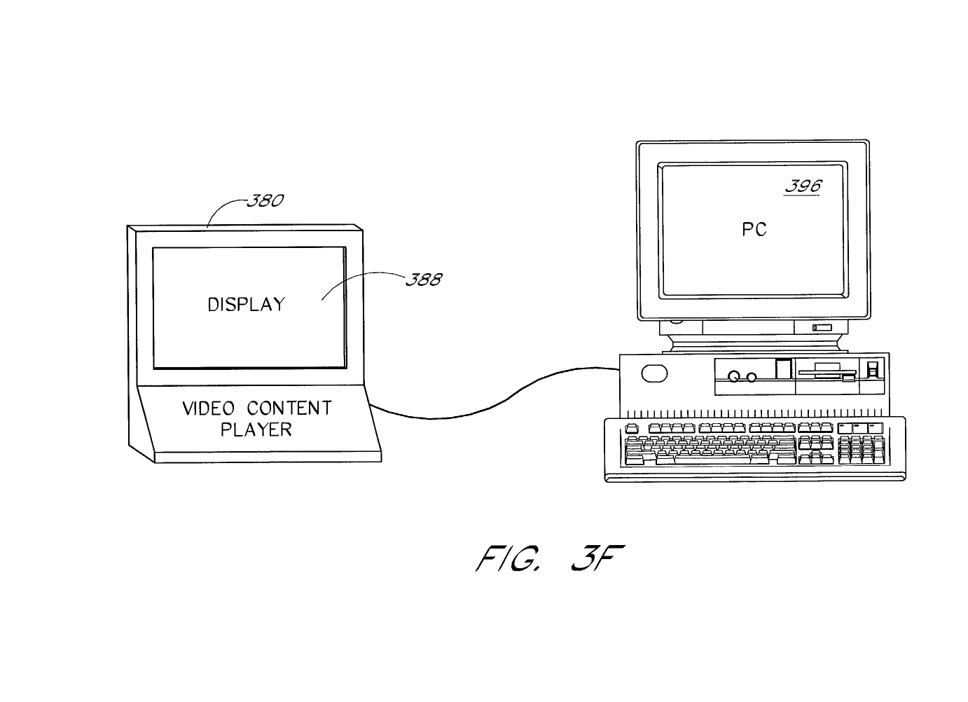

FIG. 4 illustrates a preferred embodiment 400 of the kiosk 102. The kiosk 400 includes a housing 402 that is preferably configured to be located in public locations such as supermarkets, shopping malls, and stores. The housing 402 may be integrated into the wall of a structure, as are many automatic teller machines. The housing 402 may be configured to be located either indoors or outdoors.

The kiosk 400 is preferably controlled by a computer system 404. The computer system 404 preferably includes a processor 406, system memory 408, and a system hard disk 410, all of which are interconnected by a system bus 412. The computer system 404 preferably runs a Windows NT or Linux operating system, but other operating systems may be used.

The kiosk 400 includes a display 414, which is preferably a touch screen display that also serves as an input device. The user 108 preferably interacts with the computer system 404 primarily through the touch screen display 414; however, additional input devices, such as a keyboard or a keypad may be included. The kiosk 400 may also include a credit card reader 416 and a bill/coin collector 418 in order to accept payments from the user 108. A modem/network interface 420 allows the computer system 404 to communicate with the host system 202 in order to transfer billing information, download software updates, or exchange other information or instructions. The display 414, the credit card reader 416, the bill collector 418, and the modem/network interface 420 are also preferably connected to the system bus 412.

Video content is preferably stored in digital form, such as in an MPEG-2 or MPEG-4 compatible format, on a content mass storage module 422. The content mass storage module 422 is preferably a redundant array of independent disks (RAID). The content mass storage module 422 is preferably capable of holding about 300-400 gigabytes of data—sufficient to store about 100 feature-length movies or content units 303. Smaller or larger capacity arrays may be used, depending on the desired number of content units the kiosk 400 is to make available, as well as the desired quality of the content units. The computer system 404 preferably controls the storage module 422 through a connection to the system bus 412.

The kiosk 400 receives the portable storage device 104 in a receptacle 424. The configuration of the receptacle 424 corresponds to the embodiment of the portable storage device 104 that is chosen. In the case that the preferred embodiment 300 (FIGS. 3A-B) or the first alternative embodiment 350 (FIG. 3C) of the storage device 104 is used, the receptacle 424 may be a recess having a receiving connector 354 (FIG. 3C). In the case the second alternative embodiment 360 (FIG. 3D) is used, the receptacle 424 may be a removable media drive 364. The receptacle 424 is preferably configured to lock the storage device 104 in place to prevent the user 108 from removing the storage device 104 while the kiosk 400 is communicating with the storage device 104

A storage device controller 426 preferably serves as an interface between the storage device 104 (communicating through the receptacle 424) and the system bus 412. The storage device controller 426 may also be connected by a high-bandwidth bus 427 directly to the storage module 422 so that content can be transferred from the storage module 422 to the storage device 104 without loading the system bus 412. Like the receptacle, the configuration of the storage device controller 426 corresponds to the chosen embodiment of the storage device 104. In the case the preferred embodiment 300 (FIGS. 3A-B) of the storage device is used, the storage device 300 may be directly connectable to the system bus 412. In this case, the storage device controller 426 may be as simple as a protective circuit that protects the system bus 412 from unauthorized access through the receiving connector 354. The storage device controller 426 may alternatively be a more fully functional device that controls reading from and writing to the storage device 300. In the case the first alternative embodiment (FIG. 3C) of the storage device is used, the storage device controller 426 is preferably a disk drive controller. In the case the third embodiment 360 (FIG. 3D) is used, the storage device controller 426 need not be included, and the removable media drive 364 can be directly connected to the system bus 412. A functional description of one embodiment of the storage device controller 426 is described in conjunction with a storage device access unit 900 (FIG. 9) in section V below.

The kiosk 400 also includes a content input module 428 through which video content is loaded onto the kiosk 400. The content input module 428 is preferably a satellite receiver that receives broadcast satellite transmissions through a satellite dish 430. Video content is preferably encrypted, broadcast via the satellite transponder 208, and received by the content input module 428. After being received, the video content may be decrypted by the kiosk 400 or it may be left in encrypted form, to be decrypted by the set-top box 106. The host system 202 preferably communicates with the kiosk 400 via the modem/network interface 420 to indicate when new content will be broadcast and, if necessary, what content to delete from the storage module 422 in order to make room for the new content.

In a first alternative embodiment, the content input module 428 may be embodied as a network interface to a high-bandwidth network connection capable of carrying video content. In this case, the content input module 428 and the modem/network interface 420 may be combined. In a second alternative embodiment, the content input module 428 may be embodied as a broadcast signal receiver that receives signals from a local transmitting station or through a cable television service. In a third alternative embodiment, the content input module 428 may be a digital tape drive through which a service technician can manually load content onto the kiosk 400. In a fourth alternative embodiment, the content input module 428 may be a single or multiple DVD drive. In a fifth alternative embodiment, the content input module 428 and the content mass storage module 422 may be combined such that a service technician can input new content by manually replacing the storage module 422 with a storage module containing different content.

In one embodiment, several computer systems 404 with associated displays 414 and receptacles 414 are integrated into a single kiosk 400 to serve multiple users 108 simultaneously. Other components in the kiosk 400, such as the content mass storage module 422 and the content input module 428 may be shared by the multiple computer systems 404.

In the preferred embodiment, the computer system 404 is loaded with software 432 that defines the functionality of the kiosk 400. The software 432 is preferably stored on the system hard disk 410 and preferably includes an operating system and any programs necessary to control the kiosk 400. The functionality implemented through the software 432 is described in the next subsection.

B. Kiosk Functionality

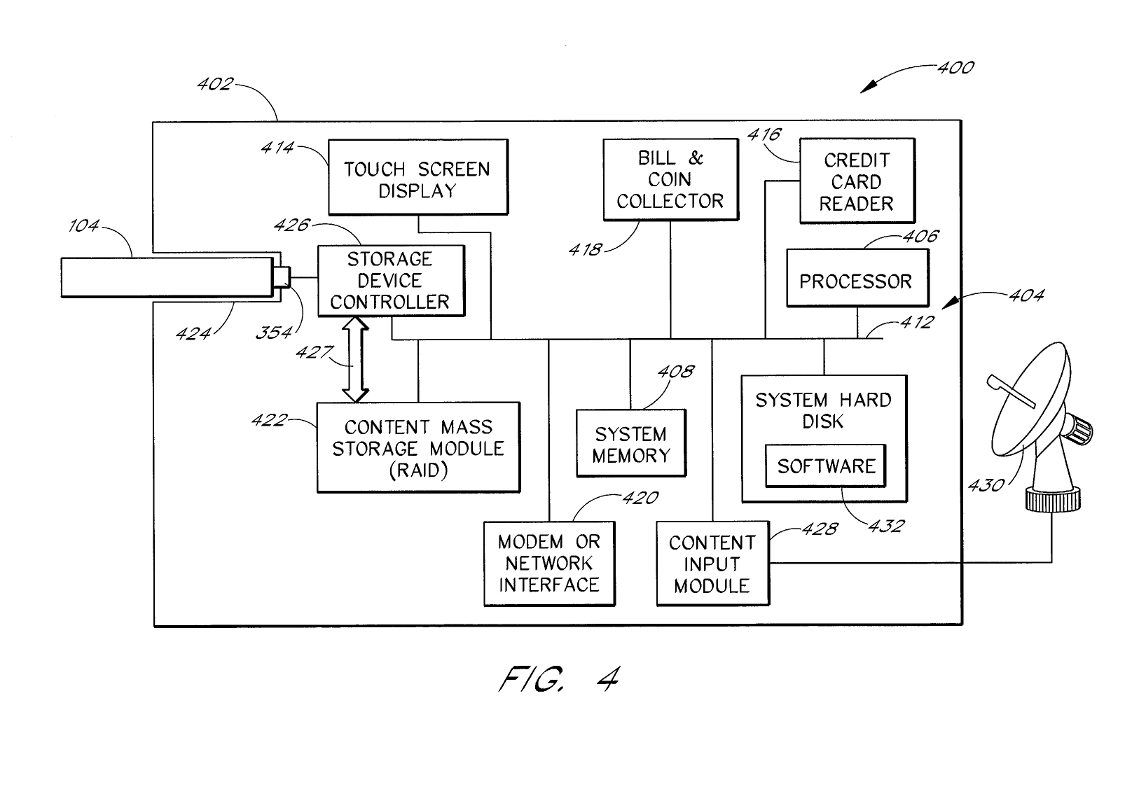

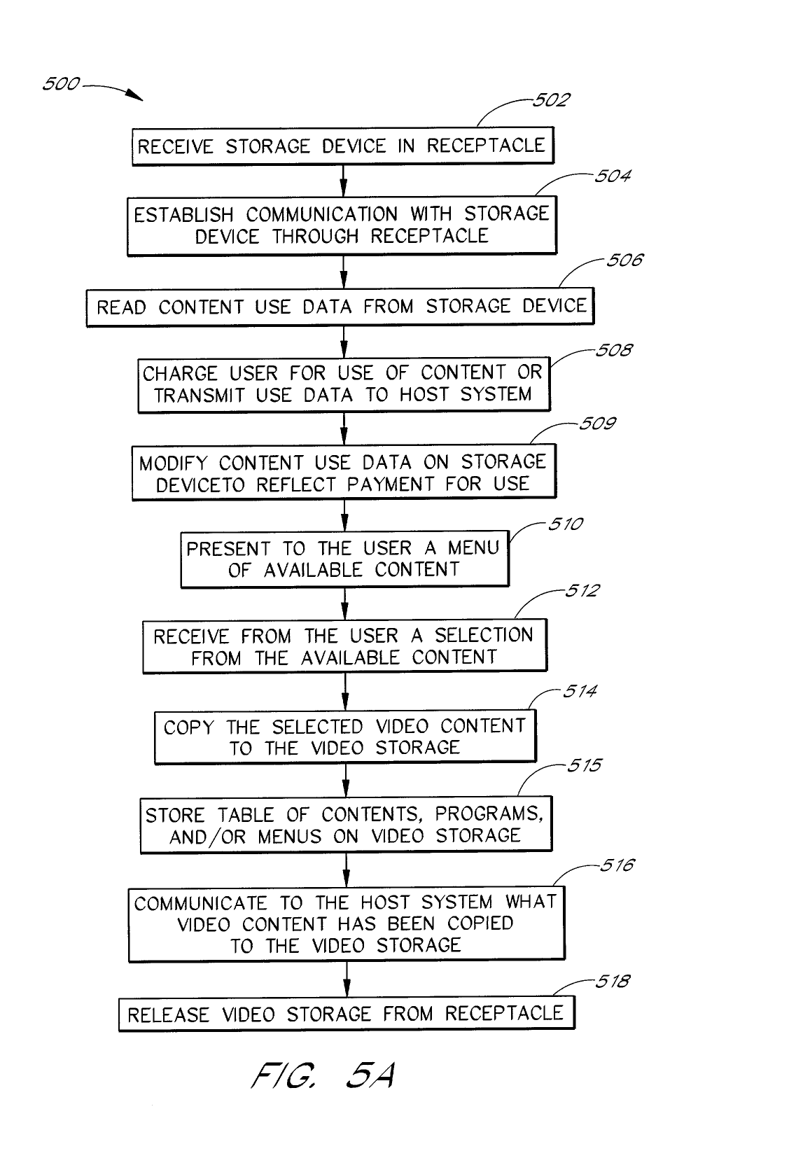

FIG. 5A illustrates a method 500 that can be performed by the kiosk 400 during a transaction with a user 108. At a first step 502, the user 108 places and the kiosk 400 receives the storage device 104 in the receptacle 424. The kiosk 400 preferably locks the storage device 104 in place so that the user 108 cannot remove the storage device 104 while data is being written to or read from the storage device 104.

At a step 504, the kiosk 400 establishes communication with the storage device 104 through the receptacle 424. The establishment of communication may include: identification/authentication of the identity of the storage device 104 by the kiosk 400; identification/authentication of the kiosk 400 by the storage device 104; enabling read access to the data stored on the storage device 104; enabling write access to store data on the storage device 104; and enabling read/write access to certain portions of the storage device's data storage capacity.

Identification may be accomplished through the exchange or transfer of an ID code. The ID code for the storage device 104 may be stored in the EPROM 332, in the nonvolatile memory 306, or in the storage module 302. The kiosk 400 may also have an ID code, which it makes available to the storage device 104. The kiosk 400 may authenticate the storage device 104 by verifying its ID code. If the storage device 104 includes sufficient security functionality, the storage device 104 may similarly authenticate an ID code provided by the kiosk 400. Authentication may also be accomplished through the use of public-private keys to avoid the bare transfer of authentication information. The kiosk 400 may pass a code to the storage device 104, which the storage device, in turn, encrypts with its private key. The storage device 104 then passes the encrypted code back to the kiosk 400. The kiosk 400 can verify, using a corresponding public key, that the code was encrypted with the private key, thus authenticating the storage device 104. The storage device 104 can authenticate the kiosk 400 similarly.

The storage device 104 may also be configured to limit or selectively allow the kiosk 400 read and write access to different portions of the storage device 104, possibly based upon the identification/authentication process. The user 108, for example, may have stored personal preferences or information on the storage device 104 to which the kiosk 400 is not allowed access. In another example, different kiosks 400 may be operated by different kiosk operators. A first kiosk operator may not want a second operator to access data that it writes to the storage device 104. Establishing communication in the step 504 may involve negotiation of allowed read and write access.

At a step 506, the kiosk 400 reads content use data 307 (FIG. 3A) written to the storage device 104 by the set-top box 106. The content use data 307 preferably includes information related to the use of the video content units, such as how much of a content unit 303 has been viewed and/or how many times it has been viewed. Content use data 307 will be described in further detail in subsection IV-B below. Other data, such as a user's responses to interactive programs (see subsection II-A) stored in the storage device's nonvolatile memory 306 may also be read at the step 506.

The storage device 104 may optionally be configured to hold content units and store content use data 307 for different kiosks 104 associated with different host systems 202 operated by different service providers. In this case, the content use data 307 may be stored separately for content units provided by each of the different kiosks 104. Alternatively, content use data 307 can be stored for and associated with each content unit 303 stored on the storage device 104.

At a step 508, the kiosk 400 either charges or bills the user 108 for the user's use of the content stored on the storage device 104. The kiosk 400 can charge the user 108 by accepting payment through the bill and coin collector 418 or through a credit card using the credit card reader 416. The kiosk 400 can alternatively bill the user 108 by transmitting the content use data 307 to the host system 202, which can coordinate the generation of bills or the charging of a user's “on file” credit card.

At a step 509, the kiosk 400 modifies the content use data 307 on the storage device 104 to reflect payment for content use. The kiosk 400 preferably removes from the content use data 307 any data loaded by the kiosk 400 or any data specifying content use for which payment has already been made. Alternatively or additionally, the kiosk 400 may write additional information to the storage device 104 indicating that certain content use has been paid for by the user 108. In order to deter illegitimate use, the kiosk 400 preferably signs, using a digital signature, the modification to the content use data 307 in a manner that can be authenticated by the set-top box 106. Asymmetric (e.g. public-private) key authentication technology can be used to produce and verify the digital signature.

At a step 510, the kiosk 400 presents to the user a menu or list of available video content. The kiosk 400 may allow the user to perform a search for a requested content unit 303 (program). Alternatively, the kiosk 400 may present available content by alphabetical order, category, or popularity. The kiosk 400 preferably allows the user 108 to make a selection from the menu or list through the touch screen display 414. The selection is preferably a selection of a single content unit 303, but may be a selection of more than one content unit 303. The kiosk 400 may make each content unit 303 available in more than one form. Various forms and options may include HDTV, PAL, NTSC, wide-screen, surround-sound, close captioned, language dubbed, and subtitled, for example. The kiosk preferably allows the user to select the form and/or options for the content unit 303. The kiosk may by default use options selected by the user in a set of user preferences stored on the storage device 104. The kiosk 400 may, however, allow the user to override the stored preferences.

In one embodiment, the kiosk 400 allows or requires the user to pay for the content unit 303 in advance, before the content unit 303 is loaded onto the storage device 104. The kiosk 400 can accept the payment using the credit card reader 416 or the bill collector 418. The user can pay for one viewing, several viewings, or an unlimited number of viewings.

It may be the case that there is not sufficient room on the storage device 104 to store the content selected by the user. The kiosk 400 can be configured to display the amount of space available on the storage device 104. The kiosk 400 can also be configured to let the user identify and delete content from the storage device to free up space. For example, the kiosk 400 can be configured to display a file list with file sizes for the associated files stored on the device. The user can select files and the kiosk can show the total space that will be freed up by files selected for deletion as the files are selected. When a sufficient number of files have been selected to free up the required space, the user can be given the option to confirm deletion of the selected files. The kiosk may also be configured to present to the user alternative formats of smaller file size that can fit onto the available space on the storage device. For example, the kiosk can provide options of high, medium, and low quality where the respective file sizes decrease with decreasing quality. The kiosk 400 can also be configured to automatically select a file format or level of compression with a corresponding file size that will fit on the available space on the device 104.

At a step 512, the kiosk 400 receives the user's selection from the available video content, and, at a step 514, the kiosk 400 copies the selected content unit 303 to the storage device 104. The amount of time it takes the kiosk 400 to copy the content unit 303 depends upon the size of the content unit 303 and the data transfer rate between the kiosk 400 and the storage device 104. The Ultra Direct Memory Access/66 protocol can sustain about 50 megabytes per second of data transfer and can be used in conjunction with PCI bus technology to connect the kiosk 400 to the storage device 104. At this data rate, it should take approximately 72 seconds to transfer a 3.6 gigabyte content unit 303.

While the content unit 303 is being copied to the storage device 104, the kiosk 400 can allow the user 108 to select additional content units to be loaded on to the storage device 104. The kiosk 400 can also present advertisements or movie trailers on the touch screen during the copying process.

At a step 515, the kiosk 400 preferably loads into the storage device's nonvolatile memory 306 a table of contents 305 listing the content units stored on the storage device 104. The kiosk may also update the nonvolatile memory 206 with any programs or menus that may be used by the set-top box 106 to access the content units. The table of contents 304, programs, and/or menus may alternatively be stored on the storage device's storage module 302.

At a step 516, the kiosk 400 communicates to the host system 202 the identity of the storage device 104 and what content units have been copied to the storage device 104. The host system 202 can use this information to track copies of content units. The host system 202 may also charge the user 108 for the use of the copied content units in the case the storage device is not again reconnected to a kiosk 400 within a predetermined amount of time (e.g., 2 months). The user 108 eventually returns the storage device 104 to a kiosk 400, and the host system 202 finally obtains the use data for the content and can credit the user 108 for content paid for but not used.

At a step 518, the kiosk 400 releases the storage device 104 and preferably prompts the user 108 to remove the storage device 104 from the receptacle 424. The user 108 then can take the storage device 104 home and view the video content units on the set-top box 106. Alternatively, if the storage device incorporates a display or audio/video outputs, the user can view the content units right from the storage device.

FIG. 5B illustrates a method 530 by which the kiosk 400 can obtain new content units for distribution. At a first step 532, the kiosk 400 receives a message from the host system 202 indicating a pending transmission of new video content via a satellite signal. The message may be transmitted through the communications network 204 or via the satellite signal itself.

At a next step 534, the kiosk 400 communicates with the host system to determine what old content stored on the kiosk's content mass storage module 422 is to be deleted or overwritten in order to store the new content. The communication may be a two-way communication between the kiosk 400 and the host system 202 through the communications network 204. In this case, the host system 202 can provide different instructions to different kiosks 400, enabling different kiosks to contain different sets of content. The kiosk 400 may also, at this time, transfer accumulated content use data 307 to the host system. Alternatively, the communication may be a one-way transmission of information from the host system 202 to the kiosk 400. In this case, the different kiosks 400 may receive the same instructions. Alternatively, instructions transmitted via the satellite signal can be coded for each kiosk 400 such that each kiosk 400 receives an individual set of instructions. The indication of the pending transmission in the step 532 and the indication of the old content to be overwritten in the step 534 allow the kiosk 400 to prepare to receive, process (e.g., decrypt, if necessary), and store the new content.

At a next step 536, the kiosk 400 receives the new content via the satellite signal and stores the new content on the content mass storage module 422. The new content is preferably encrypted during the transmission process to limit unauthorized access. In the preferred embodiment, the new content is left encrypted and the decryption process is performed upon presentation by the set-top box 106. In another embodiment, the new content is decrypted as it is received and is stored in unencrypted form by the kiosk 400. In another embodiment, the content may be stored in encrypted form and decrypted as the content is loaded onto the storage device 104. Other configurations will also be apparent to one skilled in the art.

IV. The Set-top Box

A. Set-top Box Components

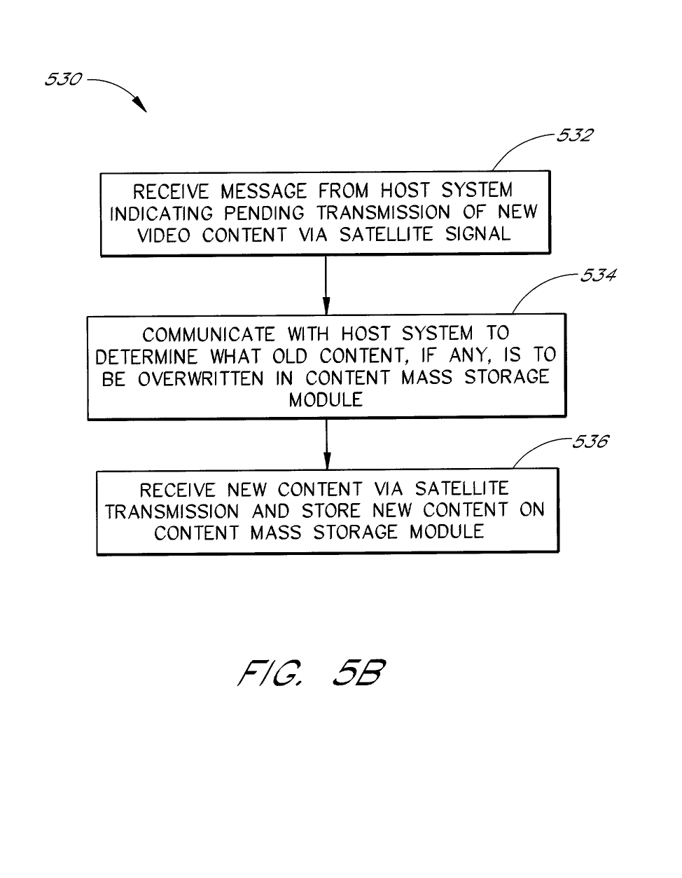

FIG. 6 illustrates a preferred embodiment 600 of the set-top box 106 (FIG. 1A). The set-top box 600 includes a housing 602 and is preferably configured to be located in a user's home and to output a signal to a television set 110 (FIG. 1A) or other video display unit. The set-top box 600 may also be configured to operate in conjunction with and output a signal to a personal computer.

The set-top box 600 includes and is controlled by a computer system 604. The computer system 604 preferably includes a processor 606, a system memory 608, a nonvolatile memory 610, and an EPROM or ROM 611, all of which are interconnected by a system bus 612. The processor 606, which may be a general purpose microprocessor or a microcontroller, preferably executes system code which is stored in the EPROM 611. The nonvolatile memory 610 is preferably used instead of a hard disk to store data while the set-top box 600 is turned off between operating sessions. The computer system 604 is preferably a special purpose computer system as opposed to a general purpose computer system like most desktop personal computers. For example, unlike typical desktop computers, the computer system 604 may not be configured to run off-the shelf programs, may not have an ASCII keyboard, and may not have a floppy disk drive.

The portable storage device 104 is received by the set-top box 600 in a receptacle 614, similar to the kiosk receptacle 424 (FIG. 4). The configuration of the receptacle 614 corresponds to the embodiment of the portable storage device 104 that is chosen. In the case that the preferred embodiment 300 (FIGS. 3A-B) or the first alternative embodiment 350 (FIG. 3C) of the storage device 104 is used, the receptacle 614 may be a recess having a receiving connector 354 (FIG. 3C). In the case the second alternative embodiment 360 (FIG. 3D) is used, the receptacle 614 may be a removable media drive 364. The receptacle 614 is preferably configured to lock the storage device 104 in place to prevent the user 108 from removing the storage device 104 while the set-top box 600 is communicating with the storage device 104.

A storage device controller 616, similar to the kiosk storage device controller 426 (FIG. 4), preferably serves as an interface between the storage device 104 (communicating through the receptacle 614) and the system bus 612. A high-bandwidth bus 618 preferably connects the storage device controller 616 directly to a video decoder module 620 so that content can be transferred from the storage device 104 to the video decoder module 620 without loading the system bus 612. Like the receptacle 614, the configuration of the storage device controller 616 should correspond to the chosen embodiment of the storage device 104.

The video decoder module 620 is preferably an integrated circuit configured to process the content units as they are read from the storage device 104 and to output video and audio signals 622 formatted for display on a television 110. The processor 606 preferably controls the video decoder module 620 through the system bus 612.

In addition, the video decoder module 620 may include copy protection technology, such as Macrovision encryption (www.macrovision.com), which prevents the output signal 622 from being copied by conventional VCRs. The video decoder module 620 preferably also has the capability to display text and graphics generated and/or communicated by the processor 606 (on-screen display). The text and graphics can be in the form of an overlay over the presentation of content or may be displayed instead of content as the output signal 622.

A gateway 624 connects the system bus 612 to the high-bandwidth bus 618. The gateway 624 allows the processor 606 to monitor and access the high-bandwidth bus 618 and accordingly access content data as it is transferred to the decoder module 620 from the storage device controller 616.

The set-top box 600 preferably also includes a user display 626 and operational controls 628. The user display 626 is preferably a small LCD screen. The operational controls 628 may be limited (e.g., only a power button) or more extensive (e.g., play, stop, fast forward, and rewind). The majority of operation functions are preferably accessed by the user 108 through a remote control 630, which transmits infrared (IR) signals to an IR receiver 632. The processor 606 communicates with the IR receiver 632 to interpret user commands. The processor 606 preferably responds to the user 108 through the on-screen display capability of the decoder module 620.

B. Content Use Data

In the preferred embodiment, the set-top box 600 preferably creates content use data 307 (FIG. 3A) and writes the data to the storage device 104. In an alternative embodiment, the content use data 307 is created by the storage device 104 itself.

Content use data 307 includes information related to the use of the video content units, such as how much of a content unit 303 has been viewed and/or how many times it has been viewed. The kiosk 102 subsequently reads the content use data 307 in order to determine how much to charge or bill the user 108 for the use of the content units 303 stored on the storage device 104.

In a preferred embodiment, content use data 307 is stored in a separate data structure for each content unit 303 stored on the storage device 104. This embodiment is well suited to supporting a system of different kiosks 102 associated with different host systems 202 operated by different service providers. Different content units can be provided by different kiosks 102, and separate content use data 307 can be associated with each content unit 303. In alternative embodiments, content use data 307 for all of the content units on the storage device 104 may be stored in the same data structure. This embodiment is better suited to the situation when all kiosks 102 are operated through the same host system 202.

In one embodiment, the set-top box 600 or the storage device 104 can be configured to display the content use data 307 to the user 108. The set-top box 600 or the storage device 104 can be configured to display how much content has been used and/or how much the user will be charged for the use. This information can be provided through an on-screen menu through an output signal from the device 104 or the set-top box. 600. Alternatively, a small display can be provided on either the set-top box 600 or the device 104.

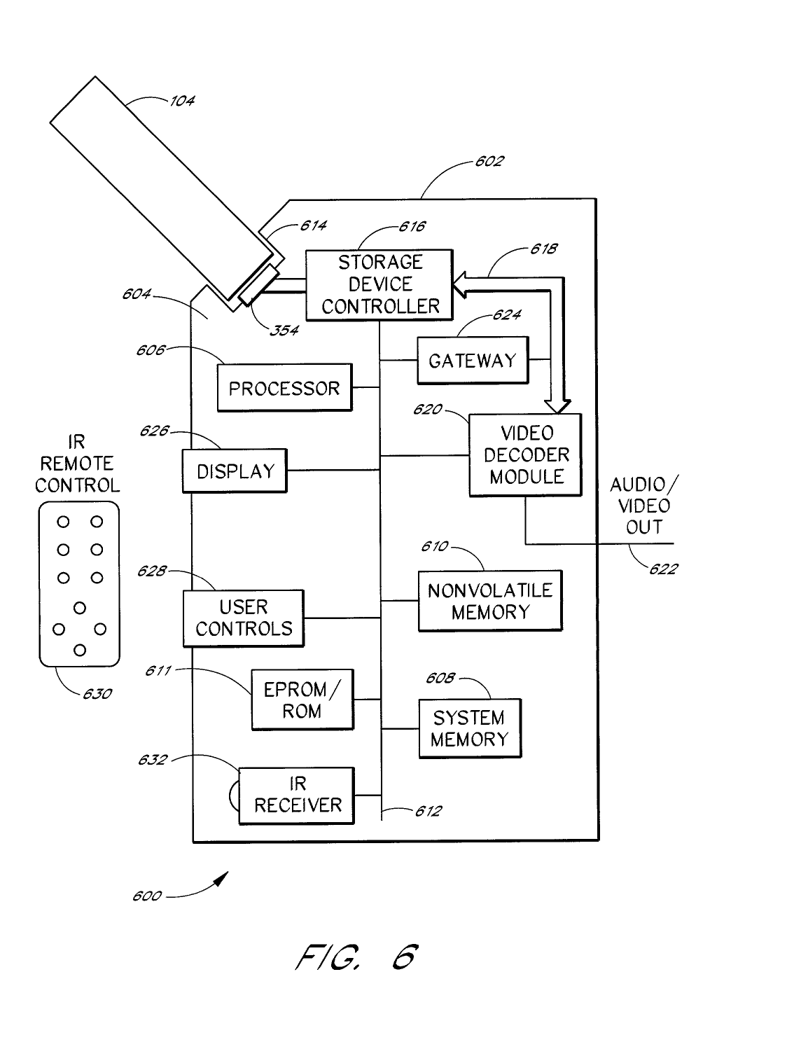

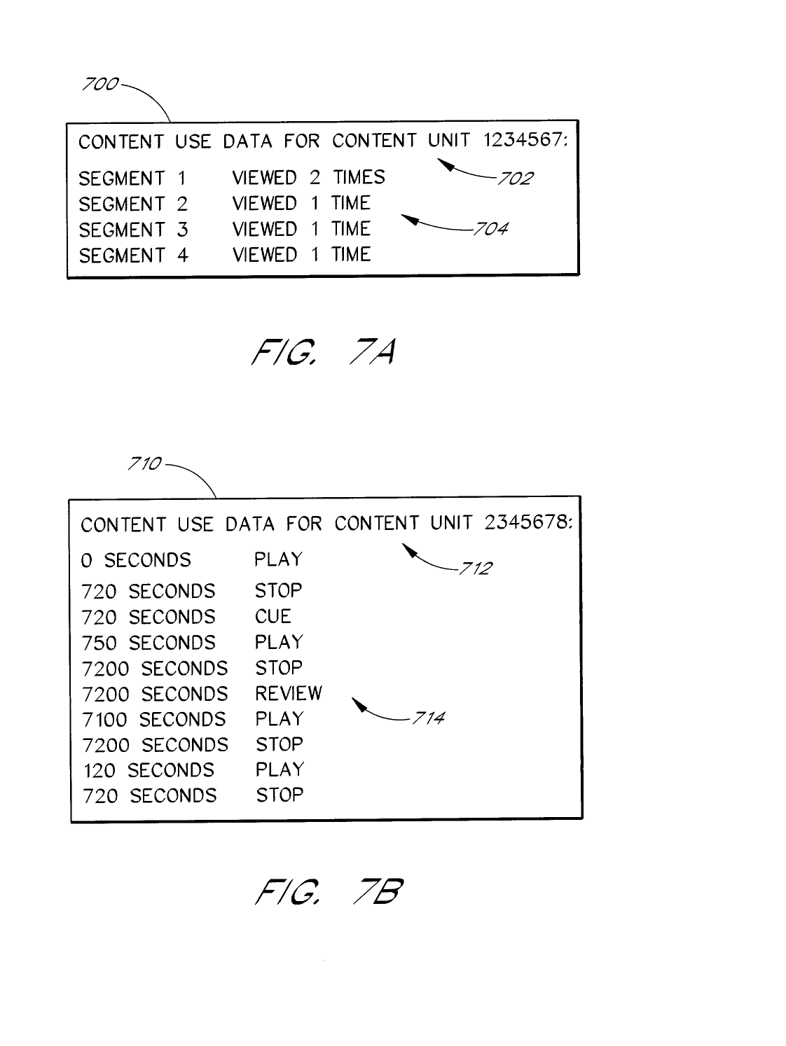

FIG. 7A illustrates a first embodiment of the content use data 307. A data structure 700 has a header 702 identifying the content unit (#1234567) for which the data structure 700 stores use information. The header 702 is preferably followed by several data elements 704, which are shown one per line. Each data element 704 indicates the number of times a particular segment of the content unit 303 has been presented. In order to determine when a segment of a content unit 303 has been presented, a marker can be incorporated into the content unit 303, which, when processed, indicates that the associated segment has been presented. A content unit can be divided into one, two, four, or more segments. As more segments are used, more content use data 307 can be collected. The marker is preferably stored near or at the beginning of each segment. The use of segments as a rubric for determining the use of a content unit 303 is conveniently compact, yet provides a fair method of determining charges for use. By using segments, the user 108 can easily be charged for portions of a full viewing. For example, the user may be proportionally charged $4 per viewing for a first viewing and proportionally charged $2 for additional viewings. Suppose a content unit has 4 segments, yet only the first segment was viewed. The user likely watched the first portion of a movie and decided it wasn't worth watching the rest. In this case, the user is proportionally charged only $1 for the segment viewed. Suppose, however, that 5 segments have been presented, each segment once, and the first segment a second time. It is likely that the content unit has been at least watched once in its entirety. Further, the user 108 may have replayed some portions of the content unit that he may have missed or wished to watch again. In this case, the user 108 is charged $4 for the first full viewing and $0.50 for the additional ¼ viewing at the lower rate for a total of $4.50.

The data structure 700 is preferably created by the set-top box 600 and written to the storage device 104. During subsequent use sessions of the same content unit 303, the previously written data structure 700 can be read from the storage device 104 by the set-top box 600, and new data elements 714 can be added to the data structure 700. Alternatively, additional data structures 700 can be written to the storage device 104 during subsequent use sessions. When the storage device 104 is again connected to a kiosk 102, the kiosk 102 can read the data structure(s) 700 and charge the user 108 accordingly.

FIG. 7B illustrates a second embodiment of the content use data 307. A data structure 710 has a header 712 similar to the header 702 (FIG. 7A). The header 712 is preferably followed by several data elements 714, which are shown one per line. Each data element 714 indicates a position within the content unit and an associated action requested by the user 108 at the time. If, for example, a content unit has a 2 hour duration, positions can be identified by the corresponding second during playback, from 0 to 7200 seconds. Actions can include, for example, play, stop, cue (view fast), and review (view in reverse fast). Other actions such as fast forward and rewind can be included, but are not necessary since no presentation preferably occurs during fast forward and rewind.

The data structure 710 is preferably created by the set-top box 600 and written to the storage device 104. During subsequent use sessions of the same content unit 303, the previously written data structure 710 can be read from the storage device 104 by the set-top box 600, and new data elements 714 can be added to the use data 710. Alternatively, additional data structures 710 can be written to the storage device 104 during subsequent use sessions. When the storage device 104 is again connected to a kiosk 102, the kiosk 102 can read the data structures 710, reconstruct how much of a content unit 303 has been presented, and charge the user 108 accordingly.

In accordance with one embodiment, the content use data or the data structure containing the content use data can be digitally signed by the set-top box to prevent manipulation by a user. In one embodiment, two versions of the content use data can be maintained and written to alternately such that if power to the set top box is lost or shut off during the writing of one version, causing corruption, the other version remains still intact. In the case that a storage device 104 is returned to a kiosk 102 with no content use data or corrupt content use data, indicating tampering, the user can be charged for the purchase price of the content.

C. Set-top Box Functionality

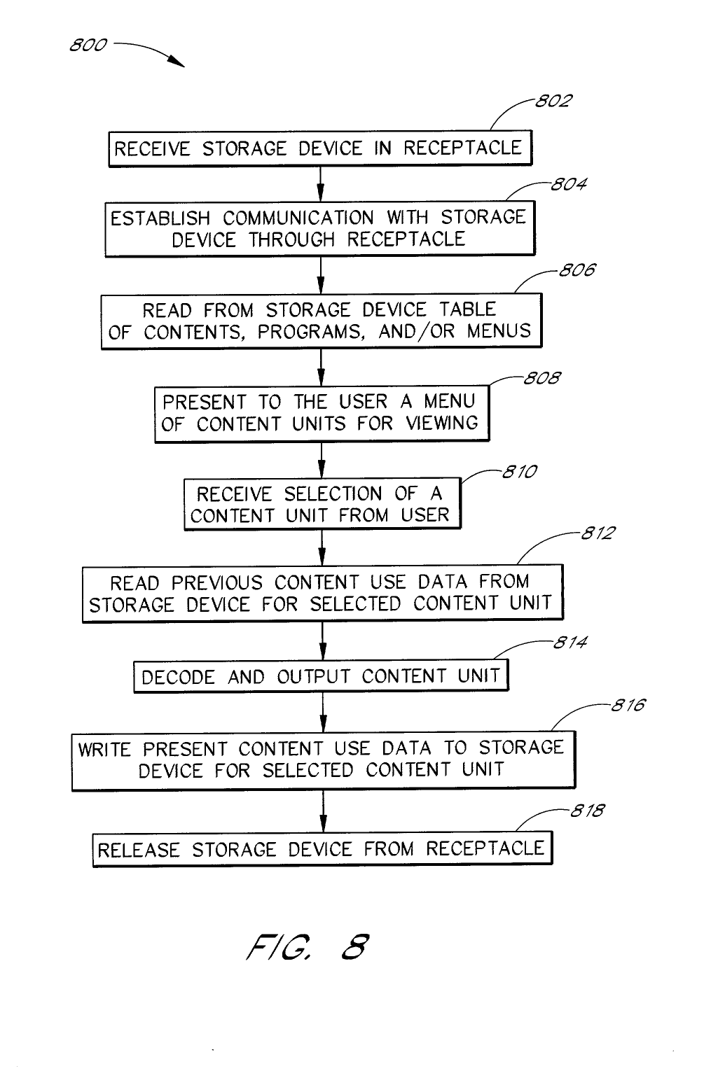

FIG. 8 illustrates a method 800 that can be performed by the set-top box 600 in displaying content units stored on the storage device 104. At a first step 802, the user 108 places and the set-top box receives the storage device 104 in the receptacle 614. The set-top box 600 preferably locks the storage device 104 in place so that the user 108 cannot remove the storage device 104 while data is being read from or written to the storage device 104.

At a step 804, the set-top box 600 establishes communication with the storage device 104 through the receptacle 614. The establishment of communication may include: identification/authentication of the identity of the storage device 104 by the set-top box 600; identification/authentication of the set-top box 600 by the storage device 104; enabling read access to the data stored on the storage device 104; enabling write access to store data on the storage device 104; and enabling read/write access to certain portions of the storage device's data storage capacity. The set-top box 600 preferably uses similar identification and authentication technology to that used by the kiosk 102.

At a step 806, the set-top box 600 reads from the storage device 104 the table of contents 305 listing the content units that are stored on the storage device 104. At a step 808, the set-top box 600 presents to the user 108 a menu of content units, preferably by interpreting the storage device's table of contents 305. The menu may alternatively be generated by interpreting programs and/or menus stored on the storage device 104. At a step 810, the set-top box 600 receives from the user a selection of a content unit 303 to be viewed.

At a step 812, the set-top box 600 reads previously stored content use data 307 from the storage device 104 for the selected content unit 303. The set-top box 600 preferably stores the previous content use data 307 in the nonvolatile memory 610 so that the content use data 307 may be retained if the set-top box 600 is switched off or if power is interrupted. The content use data 307 may, however, be stored in the system memory 608. The set-top box 600 can modify or update the previous content use data 307 with new data as the selected content unit 303 is viewed. If the content unit 303 has not been previously used, there may be no previous content use data 307.

At a step 814, the set-top box 600 decodes and outputs the content unit 303. In presenting the content unit 303, the set-top box 600 preferably responds to user commands received from the remote control 630 through the IR receiver 632. As the content unit 303 is presented, the content use data 307 is preferably updated.

At a step 816, once the user 108 has finished using the content unit 303, the set-top box 600 writes the present, updated content use data 307 back to the storage device 104. At a step 818, the set-top box 600 releases the storage device 104 and preferably prompts the user 108 to remove the storage device 104 from the receptacle 614. The user 108 then can take the storage device 104 back to a kiosk 102 and load new content units 303 onto the storage device 104.

V. Storage Device Access Unit

FIG. 9A illustrates a preferred embodiment of a storage device access unit 900. The storage device access unit 900 enables industry standard devices to access data stored on embodiments of the storage device 104 that have been configured to be incompatible with industry standard devices. The storage device access unit 900 is preferably configured to allow a personal computer to be used to access the storage device 104.

Trusted, legitimate entities such as service providers that operate kiosk video distribution systems 200 (FIG. 2) can use the access unit 900 to set up, format, diagnose, and repair storage devices 104. The distribution of the storage device access unit 900 is preferably limited to service entities in order to prevent the general public from being able to freely access the data and content securely stored on the storage device 104.

The storage device access unit 900 preferably has a self-contained housing 902. The access unit 900 receives the storage device 104 in a receptacle 914 having a receiving connector 354. The receptacle 914 and the receiving connector 354 may be similar or identical to those used in the kiosk 400 and the set-top box 600. The access unit 900 may have its own power source or may derive operating power from the personal computer 950.

A storage device controller 916 preferably serves as an interface between the storage device 104 and the personal computer 950. The storage device controller 916 is preferably connected to the storage device 104 through the connector 354 and to the personal computer 950 through a bus 952. The bus 952 is preferably a high-speed external bus such as SCSI, FireWire (IEEE-1394) or USB-2.

The storage device controller 916 preferably includes a translation module 922 and an authentication module 924. The translation module 922 preferably translates data and/or the storage device communication protocol, used by the storage device 104, into a standard form or protocol used by the bus 952 and compatible with the personal computer 950. In accordance with the preferred embodiment of the storage device 104, the storage device communication protocol is preferably a nonstandard communication protocol. The translation module 922 may also provide any control functionality necessary to access and/or communicate with the storage device 104. The translation module 620 may also include a decryption module 923 that decrypts encrypted data as it is read from the storage device 104. The decryption module 923 may be implemented in hardware or software.

The authentication module 924 preferably provides any necessary authentication functionality that may be necessary to access the storage device 104. The authentication module 924 preferably communicates with the security module 308 (FIG. 3) of the storage device 104 to cause the storage device 104 to allow access to the access unit 900. The authentication module 924 may store any required authentication information or, alternatively, the authentication information may be stored on and/or obtained from the personal computer 950.

The translation module 922 and the authentication module 924 may be integrated into a single integrated circuit or physical module. In alternative embodiments, the authentication module 924 need not be present in the storage device controller 916. The same storage device controller 916 used in the access unit 900 may also be used as the storage device controller 426 or 616 in certain embodiments of the kiosk 400 and the set-top box 600.

FIG. 9B illustrates a first alternative embodiment 902 of the access unit 900 configured to be installed in a standard personal computer drive bay. The access unit 902 is preferably configured to be attached to a standard IDE drive cable and power connector 956. The storage device controller 916 preferably communicates with an IDE drive card 958 using a standard IDE protocol. Accordingly, the access unit 900 and storage device 104 appear to be a standard disk drive to the personal computer 950.

In a second alternative embodiment, a custom device driver can be used in conjunction with the IDE card 958 of the first alternative embodiment 902. In this case, the storage device controller 916 need only perform an electrical adaptation of the storage device communication protocol to standard IDE cable signals. The device driver appropriately interprets and translates the adapted signals.

VI. Conclusion

While certain exemplary preferred embodiments have been described and shown in the accompanying drawings, it is to be understood that such embodiments are merely illustrative of and not restrictive on the broad invention. Further, it is to be understood that this invention is not limited to the specific construction and arrangements shown and described since various modifications or changes may occur to those of ordinary skill in the art without departing from the spirit and scope of the invention as claimed. It is intended that the scope of the invention be limited not by this detailed description but by the claims appended hereto. In the claims, a portion shall include greater than none and up to the whole of a thing; encryption of a thing shall include encryption of a portion of the thing. In the method claims, reference characters are used for convenience of description only, and do not indicate a particular order for performing the method.

What is claimed is:

1. An interactive kiosk for distributing content through a portable video content storage device, the interactive kiosk comprising:
a display for displaying information to the user;
an input device for receiving input from the user;
a receptacle configured to receive the portable video content storage device;
a content mass storage module for storing a library of available video content;
a processor configured to control the kiosk so as to allow a user to copy video content onto the portable video content storage device, the processor further configured to read content use information from the portable video content storage device; and
a secure housing configured to be located in a public location.

2. The kiosk of claim 1, further comprising a content input module configured to receive new video content via a satellite link.

3. The kiosk of claim 1, further comprising an authentication module configured to authenticate the video content storage device.

4. The kiosk of claim 1, wherein the processor is further configured to read user preferences from the portable video content storage device.

5. The kiosk of claim 4, wherein the user preferences comprise a content rating limitation.

6. The kiosk of claim 4, wherein the user preferences comprise a preferred content format.

7. The kiosk of claim 1, wherein the processor is further configured to enable a user to delete video content from the portable video content storage device.

8. A method for providing and monitoring the use of video content, the method performed by an interactive kiosk located in a public location, the method comprising:
receiving a portable video content storage device in a receptacle;
presenting to the user a menu of available video content;
receiving from the user a selection from the available video content;
writing the selected video content to the portable video content storage device;
again receiving the portable video content storage device in the receptacle; and
reading data from the portable video content storage device related to the use of the selected video content.

9. The method of claim 8, further comprising reading a set of user preferences from the storage device.

10. The method of claim 9, further comprising limiting the menu of video content presented to the user based at least upon the set of user preferences.

11. The method of claim 9, further comprising identifying a format in which to write video content to the storage device based at least upon the set of user preferences.

12. The method of claim 8, further comprising overwriting video content stored previously on the portable video content storage device.

13. The method of claim 8, further comprising deleting video content stored previously on the portable video content storage device.

14. A portable video content player comprising:
a mass storage module configured to store at least about an hour of at least television-suitable quality digitally encoded video content;
a video decoder module configured to decode the video content;
a processor configured to control the video decoder module and the mass storage module, the processor configured to create content use data based upon the use of the video content;
a hand-held housing containing the mass storage module, the video decoder module, and the processor.

15. The video content player of claim 14, further comprising a communication port mounted in the housing, the communication port configured to be removably connected to an external device whereby video content can be transferred from the external device to the mass storage module.

16. The video content player of claim 15, wherein the external device is an interactive kiosk located in a public location through which a user can select video content to be transferred to the video content player.

17. The video content player of claim 15, wherein the external device is a personal computer.

18. The video content player of claim 14, wherein the processor is further configured to prevent unauthorized access to the mass storage module, the processor further configured to permit video content to be written to the mass storage module by a compatibly configured interactive kiosk.

19. The video content player of claim 14, further comprising a decryption module configured to decrypt encrypted video content.

20. The video content player of claim 14, further comprising a display for displaying decoded video content, wherein the display is attached to the hand-portable housing.

21. The video content player of claim 14, further comprising a user input device through which the decoding of video content can be controlled.

22. The video content player of claim 14, further comprising an infrared remote control receiver through which a user can control the player using an infrared remote control.

23. The video content player of claim 14, further comprising a power source.

24. The video content player of claim 14, wherein the video decoder provides an output signal comprising a video signal and an audio signal.

25. The video content player of claim 24, further comprising:
a video output port for providing the video signal to an external display device; and
an audio output port for providing the audio signal to an external audio device.

26. The video content player of claim 14, further comprising an identity verification module configured to verify the identity of a user.

27. The video content player of claim 26, wherein the identity verification module is a fingerprint reader.
